(19) United States
(12) Patent Application Publication
(10) Pub. No.: US 2014/0211515 A1
(43) Pub. Date: Jul. 31, 2014

(54) DC-DC CONVERTER AND POWER SUPPLY DEVICE HAVING DC-DC CONVERTER

(71) Applicant: TDK Corporation, Tokyo (JP)

(72) Inventors: Satoshi TOMIOKA, Minato (JP); Eiji TAKEGAMI, Minato (JP)

(73) Assignee: TDK Corporation, Tokyo (JP)

(21) Appl. No.: 14/162,040

(22) Filed: Jan. 23, 2014

(30) Foreign Application Priority Data
Jan. 25, 2013 (JP) 2013-012310
Apr. 25, 2013 (JP) 2013-092239

(51) Int. Cl. H02M 3/335

(52) U.S. Cl. CPC H02M 3/33569
USPC 363/21.02

(57) ABSTRACT

A DC-DC converter is configured with a step-down converter that outputs a output voltage having the same voltage value as an input voltage when a step-down operation stops and that outputs the first output voltage having a lower voltage value than the input voltage when the step-down operation is performed, and a resonant converter in which a voltage transfer factor is adjusted by a switching frequency of a switching element through which a resonance current flows. A step-down operation of the step-down converter is performed when the switching frequency, the voltage transfer factor and a target value for the output voltage satisfy a predetermined condition. According to the above configuration, it is possible to decrease switching loss of the step-down converter.

### CROSS-REFERENCE TO RELATED APPLICATION

This application claims priority to Japanese Patent Application Nos. 2013-12310 filed Jan. 25, 2013, and 2013-92239 filed Apr. 25, 2013 which are hereby expressly incorporated by reference herein in their entirety.

### BACKGROUND

The present invention relates to a power supply device that has a current resonant converter in which resonance of an inductor and a capacitor is used.

As disclosed in Japanese Patent Publication No. H07-236271, a current resonant converter has been known as a DC-DC converter that is highly efficient with a small switching loss. FIG. 22 shows a circuit diagram of a conventional half bridge current resonant converter. A series resonance unit that is configured with a capacitor Cr and an inductor Lr is provided at a primary side of a transformer T1 in this circuit. “Lm” is an excitation inductor of the transformer T1. Resonance of the excitation inductor Lm and the capacitor Cr is parallel resonance. A rectifying circuit that is configured with a diode D3 and a diode D4 is provided at a secondary side of the transformer T1. Anode terminals of the diodes D3 and D4 are respectively connected to both ends of a secondary winding of the transformer T1. Both cathode terminals of the diodes D3 and D4 are connected to a positive electrode side terminal of a capacitor C4. A center tap of the secondary winding of the transformer T1 is connected to a negative electrode side terminal of the capacitor C4. A resistor R_{L} that is connected to the capacitor C4 in parallel is a load resistor.

FIG. 23 shows a timing diagram of a voltage waveform and a current waveform of each part of the current resonant converter shown in FIG. 22. The first and second waveforms from the top correspond to voltage waveforms of drive voltages that are applied to gates of a transistor (FET: field effect transistor) Q3 and a transistor (FET) Q4. The third and fourth waveforms from the top correspond to voltage waveforms of voltages between sources and drains of the transistor (FET) Q3 and the transistor (FET) Q4. As recognized from the voltage waveforms, the transistor (FET) Q3 and the transistor (FET) Q4 are alternatively turned ON in between a dead time at a time ratio of substantially 50%.

The fifth and sixth waveforms from the top correspond to current waveforms of currents flowing in the transistor (FET) Q3 and the transistor (FET) Q4. The seventh waveform from the top corresponds to a current waveform of a resonance current Ir flowing in the capacitor Cr and the inductor Lr. The eighth waveform from the top corresponds to a voltage waveform of a voltage between both ends of the capacitor Cr. When the transistor (FET) Q3 is turned ON, the resonance current Ir flows in the transistor (FET) Q3. When the transistor (FET) Q4 is turned ON, the resonance current Ir flows in the transistor (FET) Q4. Each of the transistor (FET) Q3 and the transistor (FET) Q4 is turned ON when a current flows through a body diode. Because a switching operation is performed as discussed above, overlapping amounts of a voltage and a current decrease. Therefore, high efficiency and low noise for the switching operation can be realized. The ninth and tenth waveforms from the top respectively correspond to current waveforms of currents flowing in the diodes D3 and D4. As indicted by the current waveforms, when the transistor (FET) Q3 is turned ON, the current flows in the transistor (FET) Q3. When the transistor (FET) Q4 is turned ON, the current flows in the transistor (FET) Q4. Note that the resonance current Ir includes an excitation current Im. A current (a hatched area) that is obtained by subtracting the excitation current Im from the resonance current Ir is supplied to the secondary side through the transformer T1.

Next, a relationship between an input voltage Vin that is applied to a circuit in the primary side of the transformer T1 and an output voltage Vo that is output from a circuit in the secondary side of the transformer T1 is explained. FIG. 24 is an equivalent circuit of the current resonant converter of FIG. 22 in which a fundamental frequency of the current resonant converter is focused on. In the equivalent circuit of FIG. 24, the amplitude of a voltage Vs is provided by the following formula (1). The amplitude of a voltage Vac is provided by the following formula (2). A value of an equivalent load resistor Rac is provided by the following formula (3). Here, “n” corresponds to the number of turns of the primary winding when the number of turns of the secondary winding that is divided into two by the center tap is set as the standard (the number of turns of the primary winding:the number of turns of the secondary winding=n:1).

$$\begin{matrix}Vs = \frac{4}{π} \frac{Vin}{2} & ( 1 ) \\ Vac = n \frac{4}{π} Vo & ( 2 ) \\ Rac = {n}^{2} \frac{8}{{π}^{2}} {R}_{L} & ( 3 )\end{matrix}$$

In this circuit, a resonance frequency f₀ is provided by the following formula (4). A characteristic impedance Z₀ is provided by the following formula (5). A voltage transfer factor M is provided by the following formula (6). The voltage transfer factor M is obtained when Vo/Vin (=Vac/Vs) is the standard under a condition of f_{SW}=f₀.

$$\begin{matrix}{f}_{0} = \frac{1}{2 π \sqrt{LrCr}} & ( 4 ) \\ {Z}_{0} = \sqrt{\frac{Lr}{Cr}} & ( 5 ) \\ M = \frac{1}{\sqrt{{( 1 + λ - \frac{λ}{{F}^{2}} )}^{2} + {{Q}^{2} ( F - \frac{1}{F} )}^{2}}} & ( 6 )\end{matrix}$$

In the formula (6), “Q,” “λ” and “F” are respectively provided by the following formulas (7)-(9). Here, “f_{SW}” is a switching frequency of the transistor (FET) Q3 and the transistor (FET) Q4.

$$\begin{matrix}Q = \frac{{Z}_{0}}{Rac} & ( 7 ) \\ λ = \frac{Lr}{Lm} & ( 8 ) \\ F = \frac{{f}_{SW}}{{f}_{0}} & ( 9 )\end{matrix}$$

As shown in the above formula (6), when the switching frequency f_{SW} is equal to the resonance frequency f₀ (F=1), the voltage transfer factor M is equal to 1. In a condition in which F is more than 1, when F is larger, the voltage transfer factor M is smaller. The voltage transfer factor M depends on “Q” and “λ.”

A relationship between changes of the switching frequency f_{SW} and the voltage transfer factor M is explained with reference to a graph. FIG. 25 is a graph showing a relationship between “F” and the voltage transfer factor M when “λ” is equal to 0.2 (λ=0.2). FIG. 26 is a graph showing a relationship between “F” and the voltage transfer factor M when “λ” is equal to 0.5 (λ=0.5). In FIGS. 20 and 21, the voltage transfer factor M is shown in a condition in which a voltage transfer factor is equal to 1 when f_{SW} is equal to f₀ (f_{SW}=f₀) In addition, in FIGS. 20 and 21, a relationship between “F” and the voltage transfer factor M is shown under three conditions of a value of “Q,” i.e., (i) Q=0 (Rac=∞), (ii) Q=0.4 (Rac=2.5×Z₀), and (iii) Q=0.8 (Rac=1.25×Z₀).

In FIG. 25, a point A corresponds to a state in which the switching frequency f_{SW} is equal to the resonance frequency f₀. As shown in the formula (6), when the switching frequency f_{SW} is equal to the resonance frequency f₀, i.e., F=1 (f_{SW}=f₀; F=1), the voltage transfer factor M is constant regardless of a value of “Q.” A point B1 corresponds to a state in which the switching frequency f_{SW} is equal to the resonance frequency f₀ times 0.6 (0.6×f₀) under a no-load state (Q=0, in other words, Rac=∞). A point B2 corresponds to a state in which the switching frequency f_{SW} is equal to the resonance frequency f₀ times 1.6 (1.6×f₀) under the no-load state (Q=0, in other words, Rac=∞). Under the no-load state (Q=0), when “F” is changed between 0.6 to 1.6 (the switching frequency f_{SW} is changed between 0.6×f₀ to 1.6×f₀), the voltage transfer factor M is changed on a curved line that passes the point B1, the point A and the point B2. A point C1 corresponds to a state in which the switching frequency f_{SW} is equal to the resonance frequency f₀ times 0.6 (0.6×f₀) under a state of Q=0.4. A point C2 corresponds to a state in which the switching frequency f_{SW} is equal to the resonance frequency f₀ times 1.6 (1.6×f₀) under a state of Q=0.4. Under the state of Q=0.4, when “F” is changed between 0.6 to 1.6 (the switching frequency f_{SW} is changed between 0.6×f₀ to 1.6×f₀), the voltage transfer factor M is changed on a curved line that passes the point C1, the point A and the point C2. According to a comparison between the curved lines under the states of Q=0 and Q=0.4, although the switching frequency f_{SW} is the same, the voltage transfer factor M is smaller when the equivalent load resistor Rac is smaller, namely the load resistor R_{L} is smaller.

FIG. 26 shows a state similar to those shown in FIG. 25. A point A corresponds to a state in which the switching frequency f_{SW} is equal to the resonance frequency f₀. A point B1 corresponds to a state in which the switching frequency f_{SW} is equal to the resonance frequency f₀ times 0.7 (0.7×f₀) under a no-load state (Q=0, in other words, Rac=∞). A point B2 corresponds to a state in which the switching frequency f_{SW} is equal to the resonance frequency f₀ times 1.6 (1.6×f₀) under the no-load state (Q=0, in other words, Rac=∞). Under the no-load state (Q=0), when “F” is changed between 0.7 to 1.6 (the switching frequency f_{SW} is changed between 0.7×f₀ to 1.6×f₀), the voltage transfer factor M is changed on a curved line that passes the point B1, the point A and the point B2. Further, a point C1 corresponds to a state in which the switching frequency f_{SW} is equal to the resonance frequency f₀ times 0.7 (0.7×f₀) under a state of Q=0.4. A point C2 corresponds to a state in which the switching frequency f_{SW} is equal to the resonance frequency f₀ times 1.6 (1.6×f₀) under a state of Q=0.4. Under the state of Q=0.4, when “F” is changed between 0.7 to 1.6 (the switching frequency f_{SW} is changed between 0.7×f₀ to 1.6×f₀), the voltage transfer factor M is changed on a curved line that passes the point C1, the point A and the point C2. FIG. 26 shows the same manner as FIG. 25. In other words, according to a comparison between the curved lines under the states of Q=0 and Q=0.4, although the switching frequency f_{SW} is the same, the voltage transfer factor M is smaller when the equivalent load resistor Rac is smaller, namely the load resistor R_{L} is smaller.

As shown in the formula (6) and FIGS. 25 (λ=0.2) and 26 (λ=0.5), in a case in which “F” is more than 1.0, the voltage transfer factor M is smaller when “λ” is larger. Therefore, when a lower limit of an adjustable range for an output voltage Vo is lowered, it is possible to make “λ” large. However, when an excitation inductor is lowered to make “λ” large, an excitation current Im that flows in the excitation inductor increases. As a result, a conduction loss of the transistor (FET) Q3 and the transistor (FET) Q4 and a copper loss at the primary side of the transformer T1 increase. As discussed above, in the current resonant converter shown in FIG. 22, it is not possible to achieve both high efficiency and expanding the lower limit of the adjustable range for an output voltage Vo.

Next, a converter in which a step-down converter and a current resonant converter are connected in series is explained. As disclosed in Japanese Patent Publication No. 2003-199333, a converter (the step-down converter) in a former part performs control of an output voltage. A converter (a converter with a half bridge) in a latter part is operated by a constant voltage transfer factor. FIG. 27 shows a circuit diagram in which the above described technology is applied to a current resonant converter. The circuit shown in FIG. 27 is configured with a power factor improvement circuit 11, a step-down converter 12, a current resonant converter 13, a first control circuit 14, a second control circuit 15 and a command voltage generation circuit 16.

The power factor improvement circuit 11 is configured with a diode bridge BD1 that performs full-wave rectification of an alternating current (AC) voltage and a step-up chopper circuit that rectifies a current waveform to a sine wave similar to a voltage waveform. The step-up chopper circuit is configured with an inductor L1, a transistor (FET) Q1, a diode D1 and a capacitor C1. The first control circuit 14 controls ON and OFF operations of the transistor (FET) Q1 so as to set a voltage Vp that is generated at a node connected between the capacitor C1 and the diode D1 as a predetermined voltage value.

The step-down converter 12 is configured with a transistor (FET) Q2, a diode D2, an inductor L2 and a capacitor C2. The step-down converter 12 generates a voltage Vb that corresponds to a voltage at a node connected between the capacitor C2 and the inductor L2 by stepping down the voltage Vp. The second control circuit 15 controls an ON period of the transistor (FET) Q2 so as to correspond the output voltage Vo from the current resonant converter 13 with a target voltage Vtgt provided by the command voltage generation circuit 16. In other words, the second control circuit 15 adjusts a time ratio of turning ON and OFF of the transistor (FET) Q2 based on the output voltage Vo and the target voltage Vtgt. Thus, the output voltage Vo is adjusted through PWM (pulse width modulation) control performed by the second control circuit 15.

The current resonant converter 13 is configured with a transistor (FET) Q3, a transistor (FET) Q4, a capacitor C3, an inductor L3, a transformer T1, a diode D3, a diode D4 and a capacitor C4. The current resonant converter 13 performs with a predetermined voltage transfer factor. For example, the transistor (FET) Q3 and the transistor (FET) Q4 are set under a condition in which they turn ON and OFF by a resonance frequency f₀. In a case in which the transistor (FET) Q3 and the transistor (FET) Q4 are turned ON and OFF by the resonance frequency f₀, even though load resistance varies, a voltage transfer factor is not changed. As a result, the voltage Vb that is input to the current resonant converter 13 is always converted with a constant voltage transfer factor. Further, a converted voltage is output as the output voltage Vo.

As discussed above, when the transistor (FET) Q3 and the transistor (FET) Q4 are turned ON and OFF by the resonance frequency f₀, the voltage Vb that is input to the current resonant converter 13 is always converted with a constant voltage transfer factor. Therefore, when the voltage Vb that is input to the current resonant converter 13 is adjusted by the step-down converter 12, the output voltage Vo is adjusted accordingly.

As explained above, in the converter that has a configuration in which the step-down converter 12 and the current resonant converter 13 are connected in series, “λ” of the current resonant converter 13 can be set to a small value. Therefore, the efficiency of the current resonant converter 13 can be high. Further, the step-down converter 12 can adjust the voltage Vb that is input to the current resonant converter 13 so that a lower limit of an adjustable range of the output voltage Vo can be lower. However, if a switching loss in the step-down converter 12 cannot be decreased, the efficiency of the entire circuit cannot be improved.

Accordingly, an object of the present invention is to decrease a switching loss of a step-down converter in a power supply device that has a DC-DC converter in which the step-down converter and a current resonant converter are connected in series.

### SUMMARY

A DC-DC converter according to one aspect of the present invention includes: a step-down converter that outputs a first output voltage having the same voltage value as an input voltage when a step-down operation stops and that outputs the first output voltage having a lower voltage value than the input voltage when the step-down operation is performed; a resonant converter in which a voltage transfer factor is adjusted by a switching frequency of a switching element through which a resonance current flows; an output voltage detection circuit that detects one of the first output voltage and a second output voltage that is output from the resonant converter; and a control circuit that has first and second controllers and that controls the step-down converter and the resonant converter based on the detected voltage detected by the output voltage detection circuit. The first controller adjusts the voltage transfer factor of the resonant converter by changing the switching frequency between a first predetermined frequency and a second predetermined frequency that is larger than the first predetermined frequency. Further, the second controller performs the step-down operation and adjusts a step-down ratio of the step-down operation under a predetermined condition.

In the DC-DC converter according to the aspect of the present invention, the predetermined condition is a state in which the switching frequency reaches the second predetermined frequency.

Further, in the DC-DC converter according to the aspect of the present invention, the first controller adjusts the voltage transfer factor in a range that is equal to or more than a predetermined minimum voltage transfer factor. The predetermined condition is a state in which the voltage transfer factor reaches the predetermined minimum voltage transfer factor.

Further, in the DC-DC converter according to the aspect of the present invention, the step-down converter is connected to an upstream end of the resonant converter. The output voltage detection circuit detects the second output voltage as the detected voltage. Alternatively, the resonant converter is connected to an upstream end of the step-down converter. The output voltage detection circuit detects the first output voltage as the detected voltage.

A DC-DC converter according to another aspect of the present invention includes: a step-down converter that outputs a first output voltage having the same voltage value as an input voltage when a step-down operation stops and that output the first output voltage having a lower voltage value than the input voltage when the step-down operation is performed; a resonant converter in which a voltage transfer factor is adjusted by a switching frequency of a switching element through which a resonance current flows; an output voltage detection circuit that detects one of the first output voltage and a second output voltage that is output from the resonant converter; a command voltage generation circuit that outputs a target value for the second output voltage; and a control circuit that has first and second controllers and that controls the step-down converter and the resonant converter based on the target value and the detected voltage detected by the output voltage detection circuit. The first controller adjusts the voltage transfer factor of the resonant converter by changing the switching frequency between a first predetermined frequency and a second predetermined frequency that is larger than the first predetermined frequency. Further, the second controller performs the step-down operation and adjusts a step-down ratio of the step-down operation when the target value is equal to or less than a predetermined value. The step-down ratio is determined based on the target value.

In the DC-DC converter according to another aspect of the present invention, the step-down converter is connected to an upstream end of the resonant converter. The output voltage detection circuit detects the second output voltage as the detected voltage. Alternatively, the resonant converter is connected to an upstream end of the step-down converter. The output voltage detection circuit detects the first output voltage as the detected voltage.

A DC-DC converter according to another aspect of the present invention includes: a step-down converter in which a time ratio of a switching operation is controlled by pulse width modulation control, the step-down converter that outputs a first output voltage; a resonant converter in which the switching frequency is controlled by the pulse width modulation control, the resonant converter that outputs a second output voltage; an operation variable generator that generates an operation variable based on one of the first and second output voltages and a target value of the one of the first and second output voltages; a first command value generator that generates a first command value based on a first calculation value to adjust the time ratio, the first calculation value being obtained by multiplying the operation variable with a first constant; and a second command value generator that generates a second command value based on a second calculation value to adjust the switching frequency, the second calculation value being obtained by subtracting a second constant from the operation variable to generate a subtracted value, multiplying the subtracted value with a third constant to generate a multiplied value, and adding a fourth constant to the multiplied value. The first command value generator restricts the first calculation value to be equal to or less than a first restriction value that corresponds to a maximum time ratio in the pulse width modulation control. The first command value generator generates the first command value based on the restricted first calculation value. Further, the second constant is set to be a value or lower obtained by dividing the first restriction value by the first constant. The third constant is set to a second restriction value that is obtained based on a maximum switching frequency in the pulse width modulation control. The second command value generator restricts the second calculation value to be equal to or more than the second restriction value. Further, the second command value generator generates the second command value based on the restricted second calculation value.

In the DC-DC converter according to another aspect of the present invention, the step-down converter is connected to an upstream end of the resonant converter. The output voltage detection circuit detects the second output voltage as the detected voltage. Alternatively, the resonant converter is connected to an upstream end of the step-down converter. The output voltage detection circuit detects the first output voltage as the detected voltage.

In the DC-DC converter according to another aspect of the present invention, the first restriction value is equal to 1.

In a converter according to an aspect of the present invention, a step-down converter that forms a part of the converter is set to start to perform a step-down operation when any of the followings occurs: (1) a switching frequency of the current resonant converter reaches a predetermined frequency; (2) a voltage transfer factor of the current resonant converter reaches a predetermined value; and (3) a target value of an output voltage V that is output from the current resonant converter becomes a predetermined voltage value or less. Therefore, as compared with a power supply device in which a step-down converter performs a step-down operation all the time, a switching loss of the step-down converter according to an aspect of the present invention can be decreased. Further, the step-down converter of an aspect of the present invention can widen an adjustable range of the output voltage while a period in which the step-down converter performs the step-down operation is shortened.

Further, in a DC-DC converter according to an aspect of the present invention, the DC-DC converter is configured with a step-down converter and a resonant converter. A command value of both step-down converter and resonant converter is calculated by an operation variable that is generated based on an output voltage of the DC-DC converter and a target value of the output voltage. When the operation variable exceeds a predetermined value, the command value for a time ratio of the step-down converter is set to 1. The command value of a cycle for adjusting a switching frequency of the resonant converter is kept in a minimum cycle until the operation variable reaches the predetermined value. Then, the command value of the cycle for adjusting the switching frequency of the resonant converter changes in accordance with the operation variable when the operation variable exceeds the predetermined value. Because the above command value is used, the step-down converter performs a step-down operation when it is necessary. On the other hand, when it is not necessary for the step-down converter to perform the step-down operation, i.e., when the operation variable exceeds the predetermined value, a time ratio of the step-down converter is set to 1. Therefore, a switching loss of the step-down converter can be decreased. Because a command value for the step-down converter and the resonant converter is generated based on a single operation variable, stable control for the step-down converter and the resonant converter can be realized.

### BRIEF DESCRIPTION OF THE DRAWINGS

FIG. 1 is a circuit diagram that shows a configuration of a power supply device according to an embodiment of the present invention.

FIG. 2 is a graph that shows a relationship between a switching frequency and a voltage transfer factor of a current resonant converter according to an embodiment of the present invention.

FIG. 3 is a timing diagram for explaining an operation of a power supply device according to an embodiment of the present invention.

FIG. 4 is a graph that shows a relationship between a switching frequency and a voltage transfer factor of a current resonant converter according to an embodiment of the present invention.

FIG. 5 is a timing diagram for explaining an operation of a power supply device according to an embodiment of the present invention.

FIG. 6 is a circuit diagram that shows a configuration of a power supply device according to an embodiment of the present invention.

FIG. 7 is a graph that shows a relationship between a switching frequency and a voltage transfer factor of a current resonant converter according to an embodiment of the present invention.

FIG. 8 is a timing diagram for explaining an operation of a power supply device according to an embodiment of the present invention.

FIG. 9 is a schematic diagram that shows a control system of a power supply device according to an embodiment of the present invention.

FIG. 10 is a graph that shows a relationship between an operation variable and a command value of a power supply device according to an embodiment of the present invention.

FIG. 11 is a graph that shows a relationship between an operation variable and a command value of a power supply device according to an embodiment of the present invention.

FIG. 12 is a schematic diagram that shows a control system of a power supply device according to an embodiment of the present invention.

FIG. 13 is a graph that shows a relationship between an operation variable and a command value of a power supply device according to an embodiment of the present invention.

FIG. 14 is an equivalent circuit diagram in a case in which a leakage inductor of a transformer T1 corresponds to a resonance inductor according to an embodiment of the present invention.

FIG. 15 is an equivalent circuit diagram in a case in which an external inductor that is connected to a transformer T1 in series corresponds to a resonance inductor according to an embodiment of the present invention.

FIG. 16 is an equivalent circuit diagram in a case in which a leakage inductor of a transformer T1 and an external inductor correspond to a resonance inductor according to an embodiment of the present invention.

FIG. 17 is a circuit diagram for explaining a configuration of a resonance capacitor according to an embodiment of the present invention.

FIG. 18 is a circuit diagram for explaining a configuration of a resonance capacitor according to an embodiment of the present invention.

FIG. 19 a circuit diagram that shows a configuration of a current resonant converter that is configured as a hull bridge type according to an embodiment of the present invention.

FIG. 20 is a circuit diagram that shows a configuration of a rectifying circuit according to an embodiment of the present invention.

FIG. 21 is a circuit diagram for explaining an order of connection between a step-down converter and a current resonant converter according to an embodiment of the present invention.

FIG. 22 is a circuit diagram that shows a configuration of a conventional current resonant converter that is configured as a half bridge type.

FIG. 23 is a timing diagram for explaining an operation of a conventional current resonant converter.

FIG. 24 is a circuit diagram that shows an equivalent circuit of a conventional current resonant converter.

FIG. 25 is a graph that shows a relationship between a switching frequency and a voltage transfer factor of a conventional current resonant converter.

FIG. 26 is a graph that shows a relationship between a switching frequency and a voltage transfer factor of a conventional current resonant converter.

FIG. 27 is a circuit diagram that shows a configuration of a conventional power supply device.

### DESCRIPTION OF EXEMPLARY EMBODIMENTS

As discussed below, a power supply device according to an embodiment of the present invention is explained with reference to the drawings.

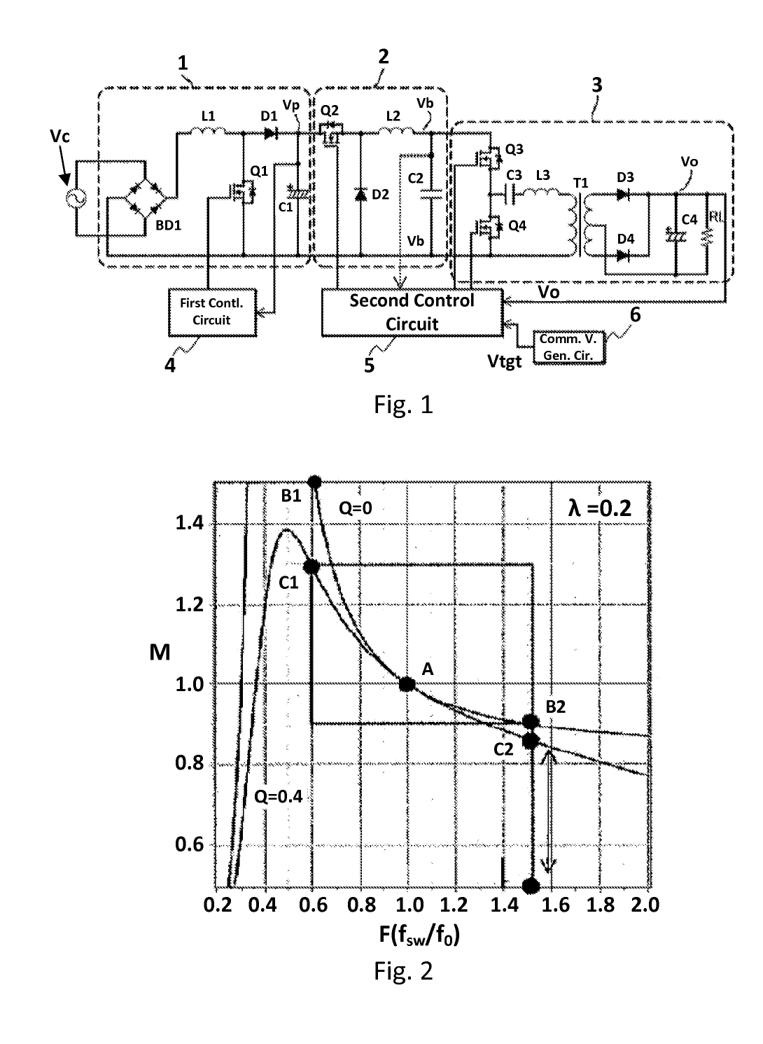

FIG. 1 is a circuit diagram of a power supply device according to an embodiment of the present invention. The power supply device is configured with a power factor improvement circuit 1, a step-down converter 2, a current resonant converter 3, a first control circuit 4, a second control circuit 5 and a command voltage generation circuit 6.

The power factor improvement circuit 1 is configured with a diode bridge BD1 and a step-up chopper circuit. Specifically, the diode bridge BD1 performs full-wave rectification of an AC voltage Vc. The step-up chopper circuit rectifies a current waveform to a sine wave similar to a voltage waveform. The step-up chopper circuit is configured with an inductor L1, a transistor (FET) Q1, a diode D1 and a capacitor C1. The first control circuit 4 controls an ON and OFF operation of the transistor (FET) Q1 so as to make a voltage Vp, which is generated at a node connected between the capacitor C1 and the diode D1, be a predetermined voltage value. The AC voltage Vc corresponds to a commercial power supply of 100V. The voltage Vp is set to be a voltage value within a range of 370-390V, for instance, 380V.

The step-down converter 2 is configured with a transistor (FET) Q2, a diode D2, an inductor L2 and a capacitor C2. The step-down converter 2 starts to perform a step-down operation under one of the following three states: (1) when a switching frequency fsw of the current resonant converter 3 reaches a predetermined frequency; (2) when a voltage transfer factor of the current resonant converter 3 reaches a predetermined value; and (3) when a target value (a target voltage Vtgt) of an output voltage Vo, which is output from the current resonant converter 3, becomes a predetermined voltage value or less. When the step-down converter 2 starts to perform the step-down operation, a time ratio for turning the transistor (FET) Q2 ON and OFF becomes less than 1. Therefore, a voltage Vb that corresponds to a voltage at a node connected between the capacitor C2 and the inductor L2 is lower than the voltage Vp. When the step-down converter 2 stops performing the step-down operation, the time ratio for turning the transistor (FET) Q2 ON and OFF is maintained to be 1. In other words, the transistor (FET) Q2 is maintained in the ON state. Therefore, the voltage values of the voltage Vb and the voltage Vp become the same.

The current resonant converter 3 is configured with a transistor (FET) Q3, a transistor (FET) Q4, a capacitor C3, a inductor L3, a transformer T1, a diode D3, a diode D4 and a capacitor C4. In the current resonant converter 3, the transistor (FET) Q3 and the transistor (FET) Q4 are alternatively turned ON in between a dead time at a time ratio of substantially 50%. Due to this switching operation, a resonance current flows in the capacitor C3 and the inductor L3. Further, the voltage transfer factor of the current resonant converter 3 can be adjusted by changing a switching frequency that performs ON and OFF operations of the transistor (FET) Q3 and the transistor (FET) Q4.

The second control circuit 5 controls the time ratio of the step-down converter 2 and the switching frequency fsw of the current resonant converter 3 so as to make the output voltage Vo that is output from the current resonant converter 3 be the same as the target voltage Vtgt that is supplied from the command voltage generation circuit 6. Specifically, the time ratio of the step-down converter 2 corresponds to the time ratio by which the transistor (RET) Q2 is turned ON and OFF. The switching frequency fsw of the current resonant converter 3 is a switching frequency by which the transistor (FET) Q3 and the transistor (FET) Q4 are turned ON and OFF. The control explained above will be explained below with reference to the drawings. In the following explanation, “λ” (λ=Lr/Lm) that is determined by an inductor Lr related to a series resonance and an inductor Lm related to a parallel resonance is set to 0.2. Further, a resonance frequency f₀ is a resonance frequency by which the capacitor C3 and the inductor L3 perform the series resonance.

### First Embodiment

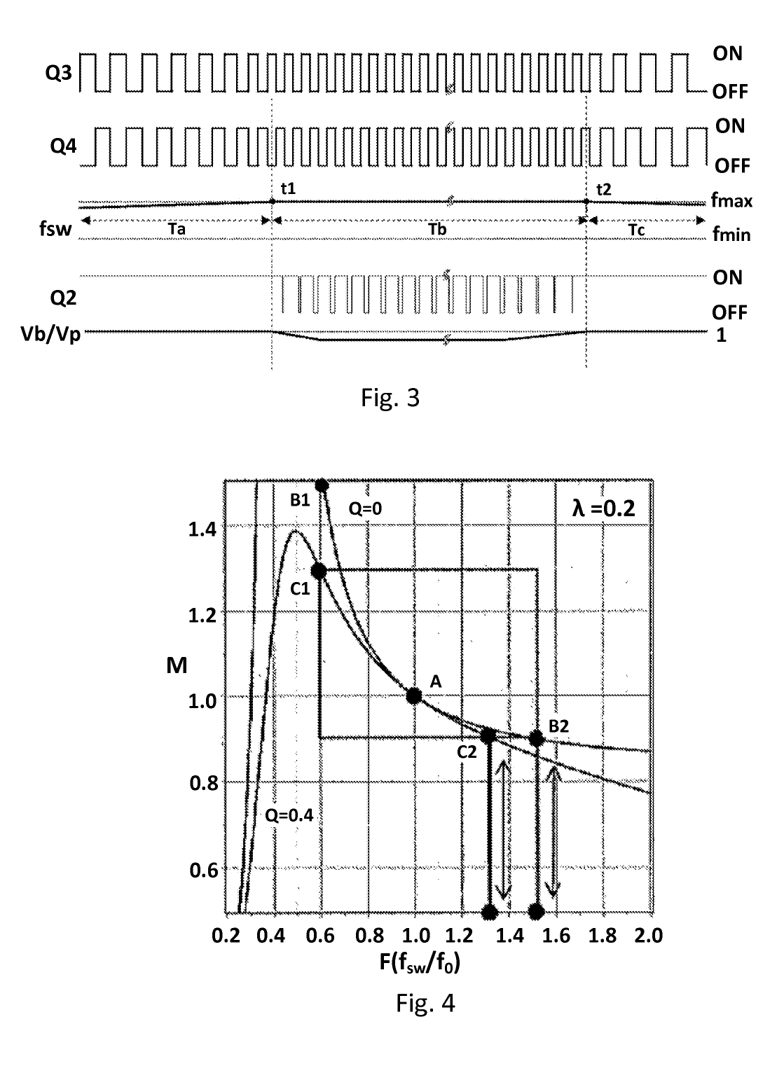

A first embodiment according to the present invention is explained with reference to FIGS. 2 and 3. FIG. 2 is a graph that shows a relationship between a switching frequency and a voltage transfer factor of the current resonant converter 3. “Q” is a value that is determined by an equivalent load resistor Rac and a characteristic impedance Z₀ (Q=Z₀/Rac). In this graph, a horizontal axis shows a ratio “F” of a switching frequency fsw (F=fsw/f₀) using a resonance frequency f₀ as a standard. A vertical axis shows a voltage transfer factor M in which the voltage transfer factor (Vo/Vb) is a standard when the switching frequency fsw is the same as the resonance frequency f₀. Therefore, when the switching frequency fsw is equal to the resonance frequency f₀ (fsw=f₀), both the ratio “F” and the voltage transfer factor “M” are 1.

A point “A” on the graph corresponds to a state in which the switching frequency fsw is equal to the resonance frequency f₀. When the switching frequency fsw is equal to the resonance frequency f₀, fsw=f₀, in other words, F=1, the voltage transfer factor M is the same value (as F) regardless of the values of Q. A point “B1” corresponds to a state in which the switching frequency fsw is 0.6 times as large as the resonance frequency f₀ (0.6×f₀) in a no-load state (Q=0, i.e., Rac=)° °. A point “B2” corresponds to a state in which the switching frequency fsw is 1.5 times as large as the resonance frequency f₀ (1.5×f₀) in the no-load state (Q=0). When F is changed between 0.6 and 1.5 in the no-load state (Q=0), i.e., when the switching frequency fsw is changed between (0.6×f₀) and (1.5×f₀), the voltage transfer factor M is changed on a curved line that passes the point B1, the point A and the point B2. Further, a point “C1” corresponds to a state in which the switching frequency fsw is 0.6 times as large as the resonance frequency f₀ (0.6×f₀) in a state in which Q is equal to 0.4 (Q=0.4). A point “C2” corresponds to a state in which the switching frequency fsw is 1.5 times as large as the resonance frequency f₀ (1.5×f₀) in the state in which Q is equal to 0.4 (Q=0.4). When F is changed between 0.6 and 1.5 in the state in which Q is equal to 0.4 (Q=0.4), i.e., when the switching frequency fsw is changed between (0.6×f₀) and (1.5×f₀), the voltage transfer factor M is changed on a curved line that passes the point C1, the point A and the point C2.

As shown in FIG. 2, the switching frequency fsw of the current resonant converter 3 is changed between a minimum frequency fmin and a maximum frequency fmax. Specifically, the minimum frequency fmin corresponds to a frequency that is 0.6 times as large as the resonance frequency f₀ (fmin=0.6×f₀). The maximum frequency fmax corresponds to a frequency that is 1.5 times as large as the resonance frequency f₀ (fmax=1.5×f₀). In this case, when the switching frequency fsw becomes the minimum frequency fmin, the voltage transfer factor M becomes the largest. When the switching frequency fsw becomes the maximum frequency fmax, the voltage transfer factor M becomes the smallest. Further, when the switching frequency fsw is different from the resonance frequency f₀, the voltage transfer factor M changes according to a value of Q. That is, when the equivalent load resistor Rac changes, the voltage transfer factor M changes accordingly. For instance, when the equivalent load resistor Rac changes in a state in which the switching frequency fsw is maintained to be the maximum frequency fmax, Q changes between 0 and 0.4. As a result, the voltage transfer factor M changes on a straight line connecting the point B2 and the point C2. Further, in the embodiment shown in FIG. 2, the voltage transfer factor M that corresponds to the point B2 is set to 0.9.

The second control circuit 5 controls the switching frequency fsw between the minimum frequency fmin and the maximum frequency fmax so as to make the output voltage Vo that is output from the current resonant converter 3 be the same as the target voltage Vtgt that is supplied from the command voltage generation circuit 6. Until the switching frequency fsw reaches the maximum frequency fmax, the voltage transfer factor M is adjusted by the control of the switching frequency fsw so as to make the output voltage Vo be the same as the target voltage Vtgt. At this time, the time ratio of the step-down converter 2 is maintained to be 1. That is, the transistor (FET) Q2 is maintained in the ON state. Thus, when the transistor (FET) Q2 is maintained in the ON state, the switching loss (loss that is generated when the transistor (FET) Q2 is turned ON or OFF), loss of the diode D2 and iron loss of the inductor L2 are not generated. As a result, the loss that is generated in the step-down converter 2 can be decreased.

On the other hand, when the switching frequency fsw of the current resonant converter 3 reaches the maximum frequency fmax, the second control circuit 5 adjusts the time ratio of the step-down converter 2 in a state in which the switching frequency fsw is maintained to be the maximum frequency fmax. At this time, the time ratio of the step-down converter 2 is smaller than and the transistor (FET) Q2 starts to perform the switching operation. That is, the step-down converter 2 starts to perform a step-down operation. As a result of this step-down operation, the voltage Vb that is input to the current resonant converter 3 is lower than the voltage Vp that is generated by the power factor improvement circuit 1. Because the voltage transfer factor M of the current resonant converter 3 cannot be smaller than this value (i.e., the minimum value) when the switching frequency fsw reaches the maximum frequency fmax, the voltage Vb decreases as explained above. When the voltage transfer factor M cannot be smaller than this value, i.e., when the switching frequency fsw reaches the maximum frequency fmax, the following control is performed. When the target voltage Vtgt that is supplied from the command voltage generation circuit 6 is lower than the output voltage Vo that is output from the current resonant converter 3, the second control circuit 5 makes the time ratio of the step-down converter 2 small. As the time ratio of the step-down converter 2 becomes smaller, the voltage Vb that is input to the current resonant converter 3 becomes lower. As a result, the output voltage Vo also becomes lower. The second control circuit 5 makes the time ratio of the step-down converter 2 smaller until the output voltage Vo is equal to the target voltage Vtgt. On the contrary, when the target voltage Vtgt is higher the output voltage Vo, the second control circuit makes the time ratio of the step-down converter 2 larger. As the time ratio of the step-down converter 2 becomes larger, the voltage Vb that is input to the current resonant converter 3 becomes higher. As a result, the output voltage Vo also becomes higher. The second control circuit 5 makes the time ratio of the step-down converter 2 larger until the output voltage Vo is equal to the target voltage Vtgt. Thus, the second control circuit 5 adjusts the voltage Vb that is input to the current resonant converter 3 and makes the output voltage Vo be the same as the target voltage Vtgt by controlling the time ratio of the step-down converter 2.

Next, operations of the step-down converter 2 and the current resonant converter 3 according to an embodiment of the present invention are explained with reference to FIG. 3. FIG. 3 is a timing diagram for explaining switching operations for the transistor (FET) Q2 of the step-down converter 2 and the transistors (FETs) Q3 and Q4 of the current resonant converter 3 according to the embodiment of the present invention. In FIG. 3, first and second waveforms from the top respectively show voltage waveforms of drive voltages that are applied to gates of the transistors (FETs) Q3 and Q4. A fourth waveform from the top shows a voltage waveform of a drive voltage that is applied to a gate of the transistor (FET) Q2. The transistors (FETs) Q2 through Q4 are turned ON when the drive voltage is in a high level and are turned OFF when the drive voltage is in a low level. Further, a third one from the top shows changes of the switching frequency fsw that makes the transistors (FETs) Q3 and Q4 turn ON and OFF. A fifth one from the top shows a ratio (Vb/Vp) between the voltage Vb that is output from the step-down converter 2 and the voltage Vp that is output from the power factor improvement circuit 1.

During a period Ta, the switching frequency fsw for the transistors (FETs) Q3 and Q4 increases and the transistor (FET) Q2 is maintained in the ON state. During this period, the second control circuit 5 controls the switching frequency fsw for the transistors (FETs) Q3 and Q4 so as to make the output voltage Vo that is output from the current resonant converter 3 be the same as the target voltage Vtgt. In this embodiment, the second control circuit 5 makes the switching frequency fsw increase so as to make output voltage Vo be the same as the target voltage Vtgt. As a result, the output voltage Vo that is output from the current resonant converter 3 decreases according to the increase of the switching frequency fsw. Then, after the switching frequency fsw reaches the maximum frequency fmax at time t1, the period shifts to a period Tb.

During the period Tb, the switching frequency fsw for the transistors (FETs) Q3 and Q4 is maintained to be the maximum frequency fmax. On the other hand, because a time ratio for turning the transistor (FET) Q2 ON and OFF is less than 1, the transistor (FET) Q2 starts to perform the switching operation. During this period, the second control circuit 5 maintains the switching frequency fsw of the current resonant converter 3 to be the maximum frequency fmax. At the same time, the second control circuit 5 controls the time ratio for turning the transistor (FET) Q2 ON and OFF so as to make the output voltage Vo that is output from the current resonant converter 3 be the same as the target voltage Vtgt. That is, as long as there is no influence of change of the equivalent load resistor Rac, the second control circuit 5 decreases the time ratio for turning the transistor (FET) Q2 ON and OFF when the target voltage Vtgt decreases. On the contrary, the second control circuit 5 increases the time ratio for turning the transistor (FET) Q2 ON and OFF when the target voltage Vtgt increases. When the time ratio for turning the transistor (FET) Q2 ON and OFF decreases, the voltage Vb that is output from the step-down converter 2 decreases. As a result, because a value of the ratio (Vb/Vp) becomes small, the output voltage Vo decreases. When the time ratio for turning the transistor (FET) Q2 ON and OFF increases, the voltage Vb that is output from the step-down converter 2 increases. As a result, because the value of the ratio (Vb/Vp) becomes large, the output voltage Vo increases. Further, when the time ratio for turning the transistor (FET) Q2 ON and OFF becomes 1, the voltage Vp is equal to the voltage Vb. As a result, the value of the ratio (Vb/Vp) is equal to 1. In this embodiment, the time ratio for turning the transistor (FET) Q2 ON and OFF is equal to 1 at time t2. Then, this period ends at time t2 and shifts to a period Tc.

During the period Tc, the switching frequency fsw for the transistors (FETs) Q3 and Q4 decreases and the time ratio for turning the transistor (FET) Q2 ON and OFF is maintained to be 1. That is, the transistor (FET) Q2 is maintained in an ON state. During this period, the second control circuit 5 controls the switching frequency fsw for the transistors (FETs) Q3 and Q4 so as to make the output voltage Vo that is output from the current resonant converter 3 to be the same as the target voltage Vtgt. In this embodiment, the second control circuit 5 makes the switching frequency fsw for the transistors (FETs) Q3 and Q4 decrease so as to make the output voltage Vo that is output from the current resonant converter 3 be the same as the target voltage Vtgt. At this time, the output voltage Vo that is output from the current resonant converter 3 increases as the switching frequency fsw decreases as long as there is no influence of the change of the equivalent resistance Rac.

As explained above, in the embodiment of the present invention, the transistor (FET) Q2 starts to perform the switching operation only when the switching frequency fsw of the current resonant converter 3 reaches the maximum frequency fmax. Therefore, as compared with a case in which the transistor (FET) Q2 performs the switching operation all the time, the loss of the step-down converter 2 can be decreased.

### Second Embodiment

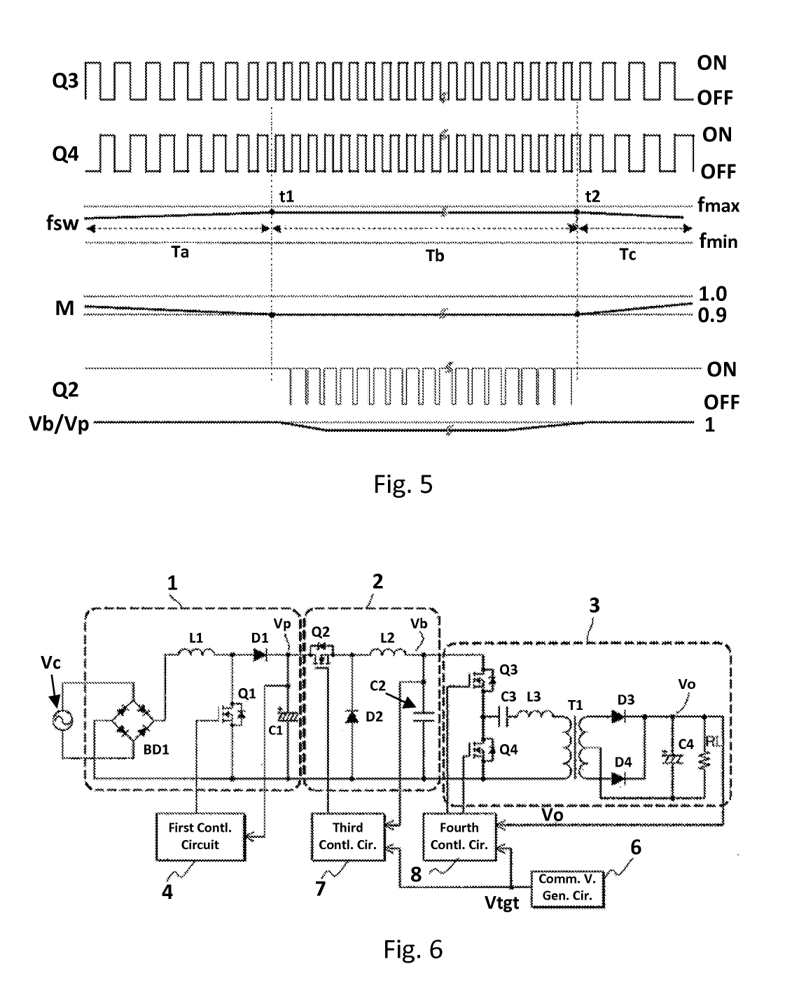

A second embodiment according to the present invention is explained with reference to FIGS. 4 and 5. FIG. 4 as well as FIG. 2 is a graph that shows a relationship between a switching frequency of the current resonant converter 3 and a voltage transfer factor. Horizontal and vertical axes in the graph of FIG. 4 as well as FIG. 2 respectively correspond to “F” (F=fsw/f₀) and a voltage transfer factor M.

A point “A” on the graph corresponds to a state in which the switching frequency fsw is equal to a resonance frequency f₀. At the time of the above state, fsw=f0 (F=1), the voltage transfer factor M maintains the same value regardless of the value of Q. A point “B1” corresponds to a state in which the switching frequency fsw is 0.6 times as large as the resonance frequency f₀ (0.6×f₀) in a no-load state (Q=0, i.e., Rac=)° °. A point “B2” corresponds to a state in which the switching frequency fsw is 1.5 times as large as the resonance frequency f₀ (1.5×f₀) in the no-load state (Q=0). Here, the voltage transfer factor M that corresponds to the point B2 is set to 0.9. In the embodiment of the present invention, a minimum value of the voltage transfer factor M is limited to be 0.9. Further, a point “C1” corresponds to a state in which the switching frequency fsw is 0.6 times as large as the resonance frequency f₀ (0.6×f₀) in a state in which Q is equal to 0.4 (Q=0.4). A point “C2” corresponds to a state in which the voltage transfer factor M is 0.9 in the state in which Q is equal to 0.4 (Q=0.4).

In this embodiment as well as the first embodiment, the switching frequency fsw of the current resonant converter 3 is changed between a minimum frequency fmin (fmin=0.6×f₀) and a maximum frequency fmax (fmax=1.5×f₀). Specifically, the minimum frequency fmin corresponds to the frequency that is 0.6 times as large as the resonance frequency f₀. The maximum frequency fmax is 1.5 times as large as the resonance frequency f₀. At this time, a lower limit of the voltage transfer factor M is set to 0.9. Therefore, when the voltage transfer factor M reaches 0.9, a range for changing the switching frequency fsw is limited. That is, in a case in which Q is larger than 0, when the voltage transfer factor M reaches 0.9, the switching frequency fsw becomes an upper limit of a variable range of the switching frequency fsw.

Until the voltage transfer factor M of the current resonant converter 3 reaches 0.9, the second control circuit 5 controls the switching frequency fsw between the minimum frequency fmin and the maximum frequency fmax so as to make the output voltage Vo that is output from the current resonant converter 3 be the same as the target voltage Vtgt that is supplied from the command voltage generation circuit 6. That is, until the voltage transfer factor M reaches 0.9, the voltage transfer factor M is adjusted by the control of the switching frequency fsw so as to make the output voltage Vo be the same as the target voltage Vtgt. At this time, the time ratio of the step-down converter 2 is maintained to be 1 and the transistor (FET) Q2 is maintained in the ON state. Thus, when the transistor (FET) Q2 is maintained in the ON state, the switching loss (loss that is generated when the transistor (FET) Q2 is turned ON or OFF), loss of the diode D2 and iron loss of the inductor L2 are not generated. As a result, the loss that is generated in the step-down converter 2 can be decreased.

In the embodiment of the present invention, the second control circuit 5 can calculate the voltage transfer factor M by detecting the output voltage Vo that is output from the current resonant converter 3 and the voltage Vb that is input to the current resonant converter 3. In other words, the voltage Vb is output from the step-down converter 2. Further, when the time ratio of the step-down converter 2 is maintained to be 1, the voltage Vp that is output from the power factor improvement circuit 1 is equal to the voltage Vb that is output from the step-down converter 2. Therefore, the voltage transfer factor M can be calculated by detecting only the output voltage Vo that is output from the current resonant converter 3. That is, under the condition in which the voltage Vp that is output from the power factor improvement circuit 1 is maintained as a predetermined voltage, the voltage transfer factor M can be calculated based on the predetermined voltage and the output voltage Vo. In this case, after the voltage transfer factor M reaches 0.9, the switching frequency fsw of the current resonant converter 3 can be maintained to be the switching frequency fsw when the voltage transfer factor M reaches 0.9.

On the other hand, when the voltage transfer factor M of the current resonant converter 3 reaches 0.9, the second control circuit 5 performs time ratio control that changes a time ratio of the step-down converter 2 in a state in which the voltage transfer factor M is maintained to be 0.9. At this time, because the time ratio of the step-down converter 2 is smaller than 1, the transistor (FET) Q2 starts to perform a switching operation. That is, the step-down converter 2 starts to perform a step-down operation. The second control circuit 5 adjusts the voltage Vb that is input to the current resonant converter 3 by controlling the time ratio of the step-down converter 2.

When the voltage transfer factor M of the current resonant converter 3 is maintained to be 0.9, the following control is performed. When the target voltage Vtgt that is supplied from the command voltage generation circuit 6 is lower than the output voltage Vo that is output from the current resonant converter 3, the second control circuit 5 makes the time ratio of the step-down converter 2 smaller. As the time ratio of the step-down converter 2 becomes smaller, the voltage Vb that is input to the current resonant converter 3 becomes lower. As a result, the output voltage Vo also becomes lower. The second control circuit 5 makes the time ratio of the step-down converter 2 smaller until the output voltage Vo becomes the same as the target voltage Vtgt. On the contrary, when the target voltage Vtgt that is supplied from the command voltage generation circuit 6 is higher than the output voltage Vo that is output from the current resonant converter 3, the second control circuit 5 makes the time ratio of the step-down converter 2 larger. As the time ratio of the step-down converter 2 becomes larger, the voltage Vb that is input to the current resonant converter 3 becomes higher. As a result, the output voltage Vo also becomes higher. The second control circuit 5 makes the time ratio of the step-down converter 2 larger until the output voltage Vo becomes the same as the target voltage Vtgt. Thus, the second control circuit 5 adjusts the voltage Vb that is input to the current resonant converter 3 by controlling the time ratio of the step-down converter 2 and makes the output voltage Vo be the same as the target voltage Vtgt.

Next, operations of the step-down converter 2 and the current resonant converter 3 according to the embodiment of the present invention are explained with reference to FIG. 5. FIG. 5 is a timing diagram for explaining switching operations for the transistor (FET) Q2 of the step-down converter 2 and the transistors (FETs) Q3 and Q4 of the current resonant converter 3 according to the embodiment of the present invention. In FIG. 5, first and second waveforms from the top respectively show voltage waveforms of drive voltages that are applied to gates of the transistors (FETs) Q3 and Q4. A fifth waveform from the top shows a voltage waveform of a drive voltage that is applied to a gate of the transistor (FET) Q2. The transistors (FETs) Q2 through Q4 are turned ON when the drive voltage is in a high level and are turned OFF when the drive voltage is in a low level. Further, a third one from the top shows change of the switching frequency fsw that makes the transistors (FETs) Q3 and Q4 turn ON and OFF. A fourth one from the top shows change of the voltage transfer factor M of the current resonant converter 3. A sixth one from the top shows a ratio (Vb/Vp) between the voltage Vb that is output from the step-down converter 2 and the voltage Vp that is output from the power factor improvement circuit 1.

During a period Ta, the switching frequency fsw of the transistors (FETs) Q3 and Q4 increases, and the transistor (FET) Q2 is maintained in the ON state. As the switching frequency fsw increases, the voltage transfer factor M decreases. During this period, while the time ratio of the step-down converter 2 is maintained to be 1, the second control circuit 5 controls the switching frequency fsw of the transistors (FETs) Q3 and Q4 so as to make the output voltage Vo that is output from the current resonant converter 3 be the same as the target voltage Vtgt. In this embodiment, the second control circuit 5 makes the switching frequency fsw increase and makes the voltage transfer factor M decrease so as to make the output voltage Vo be the same as the target voltage Vtgt. As a result, the output voltage Vo that is output from the current resonant converter 3 as well as the voltage transfer factor M decreases as the switching frequency fsw increases. Then, after the voltage transfer factor M reaches 0.9 at time t1, the period shifts to a period Tb.

During the period Tb, the voltage transfer factor M is maintained to be 0.9. On the other hand, because the time ratio of the step-down converter 2 is less than 1, the transistor (FET) Q2 starts to perform the switching operation. During this period, while the voltage transfer factor M of the current resonant converter 3 is maintained to be 0.9, the second control circuit 5 controls the time ratio for turning the transistor (FET) Q2 ON and OFF so as to make the output voltage Vo that is output from the current resonant converter 3 be the same as the target voltage Vtgt. That is, the second control circuit 5 decreases the time ratio for turning the transistor (FET) Q2 ON and OFF when the target voltage Vtgt decreases. Further, the second control circuit 5 increases the time ratio for turning the transistor (FET) Q2 ON and OFF when the target voltage Vtgt increases. When the time ratio for turning the transistor (FET) Q2 ON and OFF decreases, the voltage Vb that is output from the step-down converter 2 decreases. As a result, because a value of the ratio (Vb/Vp) becomes small, the output voltage Vo decreases. When the time ratio for turning the transistor (FET) Q2 ON and OFF increases, the voltage Vb that is output from the step-down converter 2 increases. As a result, because the value of the ratio (Vb/Vp) becomes large, the output voltage Vo increases. Further, when the time ratio for turning the transistor (FET) Q2 ON and OFF becomes 1, the value of the ratio (Vb/Vp) is equal to 1 because the voltage Vp is equal to the voltage Vb. In this embodiment, the time ratio of the step-down converter 2 is equal to 1 at time t2. Then, this period ends at time t2 and shifts to a period Tc.

During the period Tc, the switching frequency fsw of the transistors (FETs) Q3 and Q4 decreases. Further, the time ratio for turning the transistor (FET) Q2 ON and OFF is maintained to be 1. That is, the transistor (FET) Q2 is maintained in the ON state. The voltage transfer factor M increases as the switching frequency fsw decreases. During this period, the second control circuit 5 controls the switching frequency fsw of the transistors (FETs) Q3 and Q4 so as to make the output voltage Vo that is output from the current resonant converter 3 to be the same as the target voltage Vtgt. In this embodiment, the second control circuit 5 makes the voltage transfer factor M increase by making the switching frequency fsw decrease. At this time, the output voltage Vo that is output from the current resonant converter 3 increases as the voltage transfer factor M increases.

As explained above, in the embodiment of the present invention, the transistor (FET) Q2 starts to perform the switching operation only when the voltage transfer factor 3 of the current resonant converter 3 reaches a predetermined value. Therefore, as compared with a case in which the transistor (FET) Q2 performs the switching operation all the time, loss of the step-down converter 2 can be decreased.

### Third Embodiment

A third embodiment according to the present invention is explained with reference to FIGS. 6 through 8. FIG. 6 is a circuit diagram that shows a power supply device according to the embodiment of the present invention. This power supply device is configured with a power factor improvement circuit 1, a step-down converter 2, a current resonant converter 3, a first control circuit 4, a third control circuit 7, a fourth control circuit 8 and a command voltage generation circuit 6. The power factor improvement circuit 1, the step-down converter 2, the current resonant converter 3, the first control circuit 4 and the command voltage generation circuit 6 among the above circuits respectively correspond to the circuits having the same reference numerals shown in FIG. 1. Further, a target voltage Vtgt that is output from the command voltage generation circuit 6 is input to the third control circuit 7 and the fourth control circuit 8.

The third control circuit 7 controls a time ratio of the step-down converter 2 based on the target voltage Vtgt that is supplied from the command voltage generation circuit 6. Specifically, the time ratio of the step-down converter 2 corresponds to a time ratio for turning the transistor (FET) Q2 ON and OFF. In this control, a voltage value of the voltage Vb, which is output from the step-down converter 2 and which is input to the current resonant converter 3, is adjusted based on the target voltage Vtgt when the target voltage Vtgt is less than a predetermined voltage value. The predetermined voltage value is set to be a lower voltage value than a rated output voltage Vr. In the embodiment of the present invention, a voltage value of the output voltage Vo that is output from the current resonant converter 3 is determined as the rated output voltage Vr when the following two conditions are satisfied. The first condition is that a voltage Vp that is output from the power factor improvement circuit 1 is equal to the voltage Vb that is input to the current resonant converter 3, i.e., the time ratio of the step-down converter 2 is maintained to be 1. The second condition is that a switching frequency fsw of the current resonant converter 3 is equal to a resonance frequency f₀.

The fourth control circuit 8 controls the switching frequency fsw of the current resonant converter 3 based on the target voltage Vtgt that is supplied from the command voltage generation circuit 6. Specifically, the frequency fsw of the current resonant converter 3 corresponds to a switching frequency for turning the transistor (FETs) Q3 and Q4 ON and OFF. In this control, the switching frequency fsw is controlled so as to make the output voltage Vo that is output from the current resonant converter 3 to be the same as the target voltage Vtgt.

Next, control for the time ratio of the step-down converter 2 that is performed by the third control circuit 7 and control for the switching frequency fsw of the current resonant converter 3 that is performed by the fourth control circuit 8 are explained in detail with reference to FIG. 7. FIG. 7 is a graph that shows a relationship between the switching frequency fsw and a voltage transfer factor M′. On this graph, a horizontal axis corresponds to a ratio F of the switching frequency fsw (F=fsw/f₀) using the resonance frequency f₀ as a standard. A vertical axis corresponds to the voltage transfer factor M′ using a voltage transfer factor (Vo/Vp) as a standard when the voltage Vb is equal to the voltage Vp (Vb=Vp) and when the switching frequency fsw is equal to the resonance frequency f₀ (fsw=f₀). The voltage transfer factor M′ corresponds to a voltage transfer factor in consideration of both the step-down converter 2 and the current resonant converter 3. Therefore, when the voltage Vb is equal to the voltage Vp (Vb=Vp), the voltage transfer factor M′ is the same as the voltage transfer factor M of the current resonant converter 3.

In FIG. 7, a solid curved line corresponds to a state in which the voltage Vb is equal to the voltage Vp (Vb=Vp). A broken curved line corresponds to a state in which the voltage Vb is equal to 0.5 times as large as the voltage Vp (Vb=0.5Vp). As shown in the two curved lines, a voltage that is input to the current resonant converter 3 at the time of the state of (Vb=0.5Vp) corresponds to a ½ (0.5 times) of a voltage that is input to the current resonant converter 3 at a time of the state of (Vb=Vp). As a result, the voltage transfer factor M′ at the time of the state of (Vb=0.5Vp) corresponds to a ½ (0.5 times) of the voltage transfer factor M′ at the time of the state of (Vb=Vp). A point “A” on the solid curved line corresponds to a state in which the switching frequency fsw is equal to the resonance frequency f₀ (fsw=f₀). At this time, the voltage transfer factor M′ corresponds to 1. On the other hand, a point “B” on the broken curved line also corresponds to the state in which the switching frequency fsw is equal to the resonance frequency f₀ (fsw=f₀). At this time, the voltage transfer factor M′ corresponds to 0.5. At the point A, the output voltage Vo that is output from the current resonant converter 3 corresponds to the rated output voltage Vr. Therefore, at the point B, the voltage that is ½ (0.5 times) of the rated output voltage Vr is output from the current resonant converter 3 as the output voltage Vo.

The third control circuit 7 controls the time ratio of the step-down converter 2 based on the target voltage Vtgt. When the target voltage Vtgt is larger than a predetermined voltage value, the third control circuit 7 maintains the time ratio of the step-down converter 2 to be 1. It is defined that a value of the predetermined voltage corresponds to 0.9Vr (0.9 times of the rated output voltage Vr) in the following explanation.

When the target voltage Vtgt is larger than 0.9Vr, the third control circuit 7 maintains the time ratio of the step-down converter 2 to be 1. When the target voltage Vtgt is 0.9Vr or less, the third control circuit 7 controls the time ratio of the step-down converter 2 so as to make a ratio (Kref=Vtgt/Vr) between the target voltage Vtgt and the rated output voltage Vr be the same as a ratio (Vb/Vp) of the voltage Vb and the voltage Vp. Specifically, the voltage Vb is input to the current resonant converter 3 and the voltage Vp is output from the power factor improvement circuit 1. That is, when the target voltage Vtgt is 0.9Vr or less, the third control circuit 7 controls the time ratio of the step-down converter 2 so as to make the voltage Vb to be the same as a voltage of Kref times the voltage Vp (Kref×Vp). For instance, when Kref corresponds to 0.8, the third control circuit 7 controls the time ratio of the step-down converter 2 so as to make the voltage Vb be the same as the voltage of 0.8 times the voltage Vp (0.8×Vp).

Further, a method for determining a target value of the voltage Vb can be a different method than the method explained above. For instance, the target value of the voltage Vb can also be a value that is obtained by a formula of (Kref+0.05)×Vp. That is, the time ratio of the step-down converter 2 can also be controlled so as to make the voltage Vb be the same as a value that is obtained by the formula of (Kref+0.05)×Vp. In this case, when Kref corresponds to 0.9, the target value of the voltage Vp is 0.95Vp. Similarly, Kref corresponds to 0.8, the target value of the voltage Vp becomes 0.85Vp. Alternatively, the target value of the voltage Vb can also be a value that is obtained by a formula of (Kref−0.05)×Vp. That is, the time ratio of the step-down converter 2 can also be controlled so as to make the voltage Vb be the same as a value that is obtained by the formula of (Kref−0.05)×Vp. In this case, when Kref corresponds to 0.9, the target value of the voltage Vb becomes 0.85Vp. Similarly, Kref corresponds to 0.8, the target value of the voltage Vb becomes 0.75Vp.

Further, the target value of the voltage Vb can also be stepwisely changed. For instance, a value that is rounded off to a second decimal place (Kref′) can be used instead of Kref. That is, this Kref′ Vp (Kref′×Vp) can also correspond to the target value of the voltage Vb. In this case, when Kref is equal to or more than 0.85 and is equal to or less than 0.9, the target value of the voltage Vb becomes 0.9Vp. Similarly, Kref is equal to or more than 0.75 and is less than 0.85, the target value of the voltage Vb becomes 0.8Vp. Further, Kref is equal to or more than 0.65 and is less than 0.75, the target value of the voltage Vb becomes 0.8Vp.

Further, in the explanation above, the time ratio of the step-down converter 2 can be determined based on a ratio between the target voltage Vtgt and the rated output voltage Vr (Kref=Vtgt/Vr) and the step-down converter 2 can also be performed by a switching operation at this time ratio. In this case, for instance, a value that is obtained by multiplying a predetermined fixed number and Kref can also be a time ratio for the step-down converter 2.

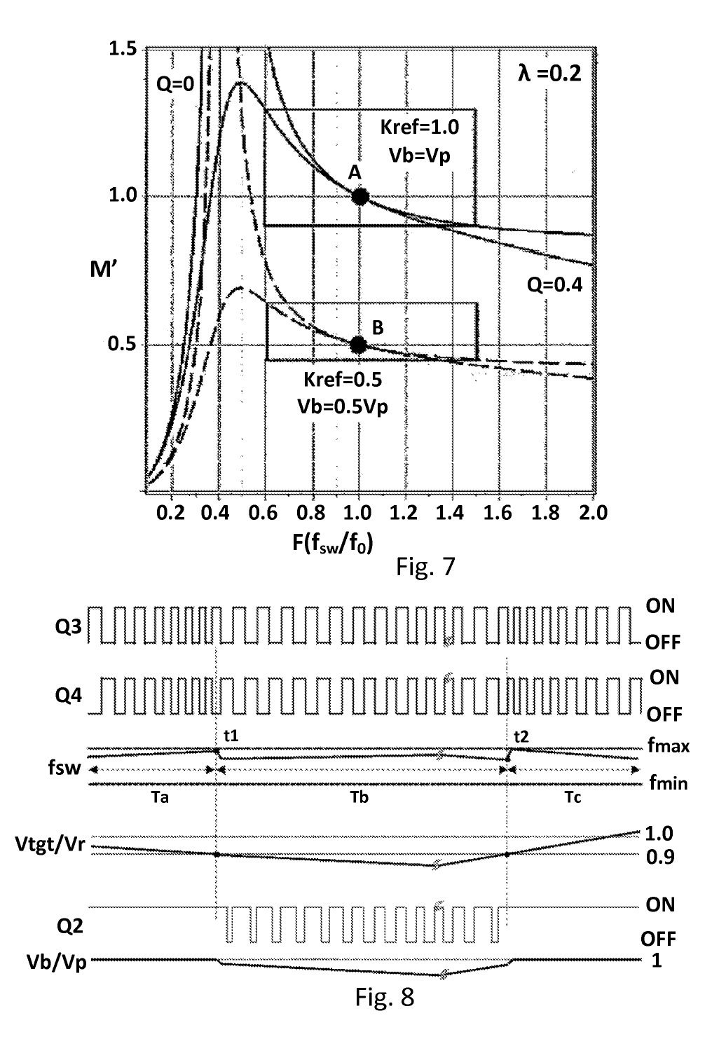

Next, operations of the step-down converter 2 and the current resonant converter 3 according to the embodiment of the present invention are explained with reference to FIG. 8. FIG. 8 is a timing diagram for explaining switching operations for the transistor (FET) Q2 of the step-down converter 2 and the transistors (FETs) Q3 and Q4 of the current resonant converter 3. In FIG. 8, first and second waveforms from the top respectively show voltage waveforms of drive voltages that are applied to gates of the transistors (FETs) Q3 and Q4. A fifth waveform from the top shows a voltage waveform of a drive voltage that is applied to a gate of the transistor (FET) Q2. The transistors (FETs) Q2 through Q4 are turned ON when the drive voltage is in a high level and are turned OFF when the drive voltage is in a low level. Further, a third one from the top shows change of the switching frequency fsw for turning the transistors (FETs) Q3 and Q4 ON and OFF. A fourth one from the top shows a ratio (Kref=Vtgt/Vr) between the target voltage Vtgt and the rated output voltage Vr. A sixth one from the top shows a ratio (Vb/Vp) between the voltage Vb that is output from the step-down converter 2 and the voltage Vp that is output from the power factor improvement circuit 1.

During a period Ta, because the target voltage Vtgt decreases, the switching frequency fsw of the transistors (FETs) Q3 and Q4 increases according to the decrease of the target voltage Vtgt. At this time, although Kref (Kref=Vtgt/Vr) also decreases, the transistor (FET) Q2 is maintained in the ON state because Kref is larger than 0.9. During this period, the third control circuit 7 maintains the time ratio for turning the transistor (FET) Q2 ON and OFF to be 1. Therefore, the voltage Vp that is output from the power factor improvement circuit 1 and the voltage Vb that is output from the step-down converter 2 are maintained to be the same voltage values. On the other hand, the fourth control circuit 8 controls the switching frequency fsw of the transistors (FETs) Q3 and Q4 so as to make the output voltage Vo that is output from the current resonant converter 3 be the same as the target voltage Vtgt. In this embodiment, the second control circuit 5 makes the switching frequency fsw of the current resonant converter 3 increase according to the decrease of the target voltage Vtgt. Then, after Kref reaches 0.9 at time t1, the period shifts to a period Tb.

During the period Tb, because Kref is 0.9 or less, the third control circuit 7 controls the time ratio for turning the transistor (FET) Q2 ON and OFF so as to make the voltage Vb be the same as a voltage of Kref times the voltage Vp (Vb=Kref×Vp). At this time, because the time ratio for turning the transistor (FET) Q2 ON and Off is smaller than 1, the transistor (FET) Q2 starts to perform a switching operation. On the other hand, the fourth control circuit 8 controls the switching frequency fsw of the transistors (FETs) Q3 and Q4 and make the output voltage Vo that is output from the current resonant converter 3 to be the same as the target voltage Vtgt. That is, the third control circuit 7 controls the time ratio for turning the transistor (FET) Q2 ON and OFF so as to make the voltage Vb to be the same as a target value (Kref×Vp). The fourth control circuit 8 controls the switching frequency fsw of the current resonant converter 3 so as to make the output voltage Vo that is output from the current resonant converter 3 be the same as a target value (the target voltage Vtgt). As long as Kref is 0.9 or less, the third control circuit 7 continues to control the time ratio of the step-down converter 2 so as to make the voltage Vb to be the same as the target value (Kref×Vp). However, when Kref is back to be larger than 0.9, the third control circuit 7 makes the time ratio of the step-down converter 2 be 1 and makes the voltage Vb be equal to the voltage Vp. In this embodiment, Kref is back to be larger than 0.9 at time t2. Then, this period ends at time t2 and shifts to a period Tc.

During the period Tc, because Kref is larger than 0.9, the transistor (FET) Q2 is in the ON state and the voltage Vb is equal to the voltage Vp. When the time ratio for turning the transistor (FET) Q2 ON and OFF is back to 1, in other words, when the transistor (FET) Q2 stops the switching operation, the voltage Vb suddenly increases. As a result, although the switching frequency fsw of the transistors (FETs) Q3 and Q4 temporarily increases, the switching frequency fsw decreases according to the increase of the target voltage Vtgt thereafter. During this period, the third control circuit 7 maintains the time ratio for turning the transistor (FET) Q2 ON and OFF to be 1. On the other hand, the fourth control circuit 8 controls the switching frequency fsw of the transistors (FETs) Q3 and Q4 so as to make the output voltage Vo that is output from the current resonant converter 3 to be the same as the target voltage Vtgt. In this embodiment, the second control circuit 5 makes the switching frequency fsw of the current resonant converter 3 decrease according to the increase of the target voltage Vtgt.

As explained above, in the embodiment of the present invention, the transistor (FET) Q2 starts to perform the switching operation only when the target voltage Vtgt is a predetermined voltage value or less. Therefore, as compared with a case in which the transistor (FET) Q2 performs the switching operation all the time, loss of the step-down converter 2 can be decreased.

### Fourth Embodiment

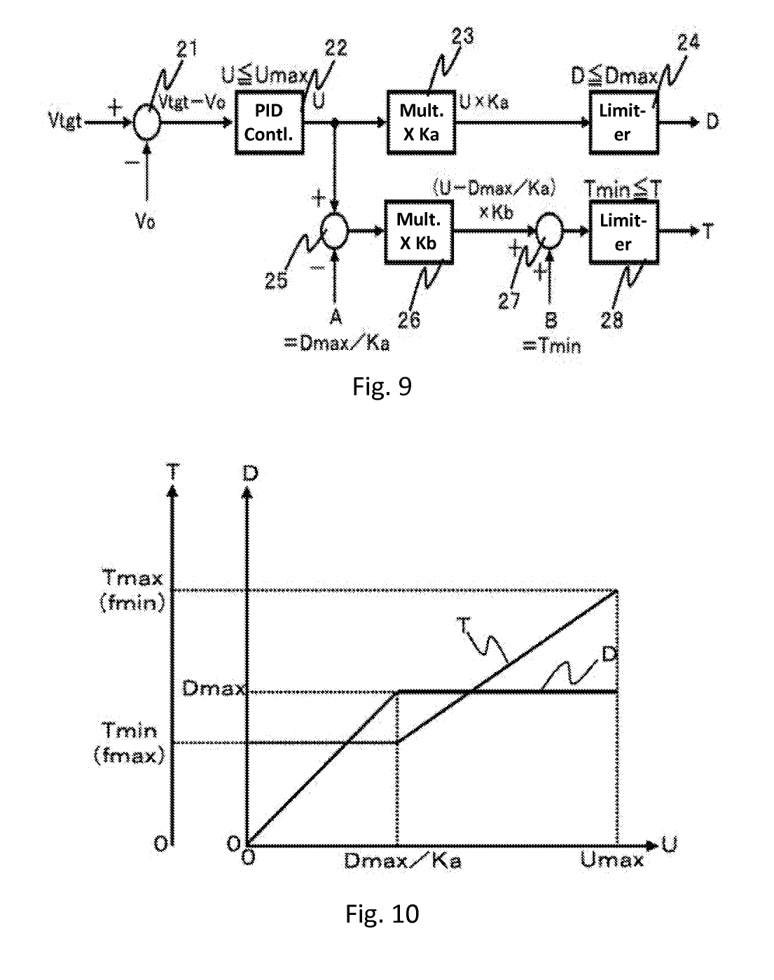

Next, a control system that controls the switching operations of the step-down converter 2 and the current resonant converter 3 shown in FIG. 1 is explained with reference to the drawings. FIG. 9 is a schematic diagram of the control system according to an embodiment of the present invention. As shown in FIG. 9, the control system is configured with a subtracter 21, a PID (proportional integral derivative) controller 22, a multiplier 23, a limiter 24, a subtracter 25, a multiplier 26, an adder 27 and a limiter 28.

In the control system, a command value (a first command value) for the step-down converter 2 in which a time ratio “D” is controlled by PWM control is generated by the subtracter 21, the PID controller 22, the multiplier 23 and the limiter 24. On the other hand, a command value (a second command value) for the current resonant converter 3 in which a switching frequency fsw is controlled by PFM (pulse frequency modulation) control is generated by the subtracter 21, the PID controller 22, the subtracter 25, the multiplier 26, the adder 27 and the limiter 28. As discussed above, the control system has two blocks, one block for generating the first command value for the step-down converter 2 and the other block for generating the second command value for the current resonant converter 3. The subtracter 21 and the PID controller 22 are commonly used by the two blocks.

Next, each element for configuring the control system is explained. The subtracter 21 subtracts an output voltage Vo from a target voltage Vtgt that is a target value for the output voltage Vo. A difference value (Vtgt−Vo) that is obtained by the above calculation is input to the PID controller 22. Note that the subtracter 21 may subtract the target voltage Vtgt from the output voltage Vo (Vo−Vtgt).

The PID controller 22 generates an operation variable “U” based on the difference value (Vtgt−Vo) or the difference value (Vo−Vtgt). The operation variable U is generated by a combination of proportional control, integral control and differential control. The PID controller 22 may generate the operation variable U by using any one of or any two of the proportional control, the integral control and the differential control. However, in a typical power supply device, it is preferred to use a controller that uses a combination of the proportional control, the integral control and the differential control, that uses a combination of the proportional control and the integral control, or that uses a combination of the proportional control and the differential control. The first command value for the step-down converter 2 and the second command value for the current resonant converter 3 are generated based on the operation variable U that is generated by the PID controller 22.

Next, a method for generating the first command value for the step-down converter 2 is explained. The operation variable U, which is generated by the PID controller, is input to the multiplier 23. The multiplier 23 outputs a value (a first calculation value) that is calculated by multiplying the operation variable U and a first constant Ka. The first calculation value (U×Ka) is restricted by the limiter in which an upper limit thereof is equal to a predetermined maximum time ratio Dmax. Thereafter, the first calculation value is output as a command value for the time ratio D for the PWM control of the step-down converter 2. In other words, when the first calculation value (U×Ka) is smaller than the maximum time ratio Dmax, the first calculation value is output as a command value for the time ratio D. Similarly, when the first calculation value (U×Ka) is equal to the maximum time ratio Dmax or when the first calculation value (U×Ka) is larger than the maximum time ratio Dmax, the maximum time ratio Dmax is output as a command value for the time ratio D.

Next, a method for generating the second command value for the current resonant converter 3 is explained. The subtracter 25 subtracts a second constant A from the operation variable U, which is generated by the PID controller, and outputs a difference value (U−A). The second constant A is set to a value that is obtained by dividing the maximum time ratio Dmax with the first constant Ka (A=Dmax/Ka). The multiplier 26 multiplies the above difference value (U−A), which is output from the subtracter 25, with a third constant Kb and outputs a multiplied value ((U−A)×Kb). The adder adds a fourth constant B to the above multiplied value and outputs as a second calculation value ((U−A)×Kb+B). The fourth constant B is, for example, set to a cycle (a minimum cycle Tmin=1/fmax) that corresponds to a maximum switching frequency fmax in the PFM control. The second calculation value ((U−A)×Kb+B) that is output from the adder 27 is restricted by limiter 28 so as to be a lower limit of the predetermined minimum cycle Tmin. Thereafter, the restricted second calculation value is output as a command value for a cycle T in the PFM control of the current resonant converter 3. This command value is for adjusting the switching frequency fsw. In other words, when the second calculation value ((U−A)×Kb+B) is equal to the minimum cycle Tmin or the second calculation value ((U−A)×Kb+B) is smaller than the minimum cycle Tmin, the minimum cycle Tmin is output as a command value for the cycle T. Similarly, when the second calculation value ((U−A)×Kb+B) is larger than the minimum cycle Tmin, the second calculation value ((U−A)×Kb+B) is output as the command value for the cycle T.

As explained above, the second command value is generated as a value for the switching cycle T, but not as a value for a switching frequency fsw. However, because the switching frequency fsw is the inverse of the switching cycle T, a command value for the switching frequency is indirectly or substantially generated by generating a command value for the switching cycle T.

Next, a relationship among an operation variable U generated by the PID controller 22, a time ratio D corresponding to the first command value for the step-down converter 2 and a cycle T corresponding to the second command value for the current resonant converter 3 is explained with reference to the drawings. FIG. 10 is a graph showing such the relationship. A horizontal axis is the operation variable U. A vertical axis is the time ratio D and the cycle T.

The time ratio D increases at constant inclination until it reaches the maximum time ratio Dmax. The inclination is determined by the first constant Ka. That is, when the first constant Ka is larger or smaller, a change ratio of the time ratio D with respect to the operation variable U is larger or smaller, respectively. Further, when the time ratio D reaches the maximum time ratio Dmax, the time ratio D is maintained to be a constant (maximum time ratio Dmax) regardless of increase of the operation variable U.

The cycle T is maintained to be a constant (minimum cycle Tmin) until the operation variable U reaches the second constant A regardless of increase of the operation variable U. After the operation variable U exceeds the second constant A, the cycle increase at constant inclination. The inclination is determined by the third constant Kb. That is, when the third constant Kb is larger or smaller, a change ratio of the cycle T with respect to the operation variable U is larger or smaller, respectively. Further, the third constant Kb is set to the following condition: when the operation variable U reaches a maximum operation variable Umax, the cycle reaches a maximum cycle Tmax (the inverse of a minimum frequency fmin). In a case in which the second constant A is set to a value that is calculated by dividing the maximum time ratio Dmax with the first constant Ka (Dmax/Ka) and in which the fourth constant B is set to the minimum cycle Tmin, when the time ratio D is changed from increase to constant, the cycle T can be changed from constant to increase. In other words, under the above condition, when the cycle T is maintained to be the minimum cycle Tmin, the time ratio D can be changed according to change of the operation variable U. Similarly, when the time ratio D is maintained to be the maximum time ratio Dmax, the cycle T can be changed according to change of the operation variable U.

### Fifth Embodiment

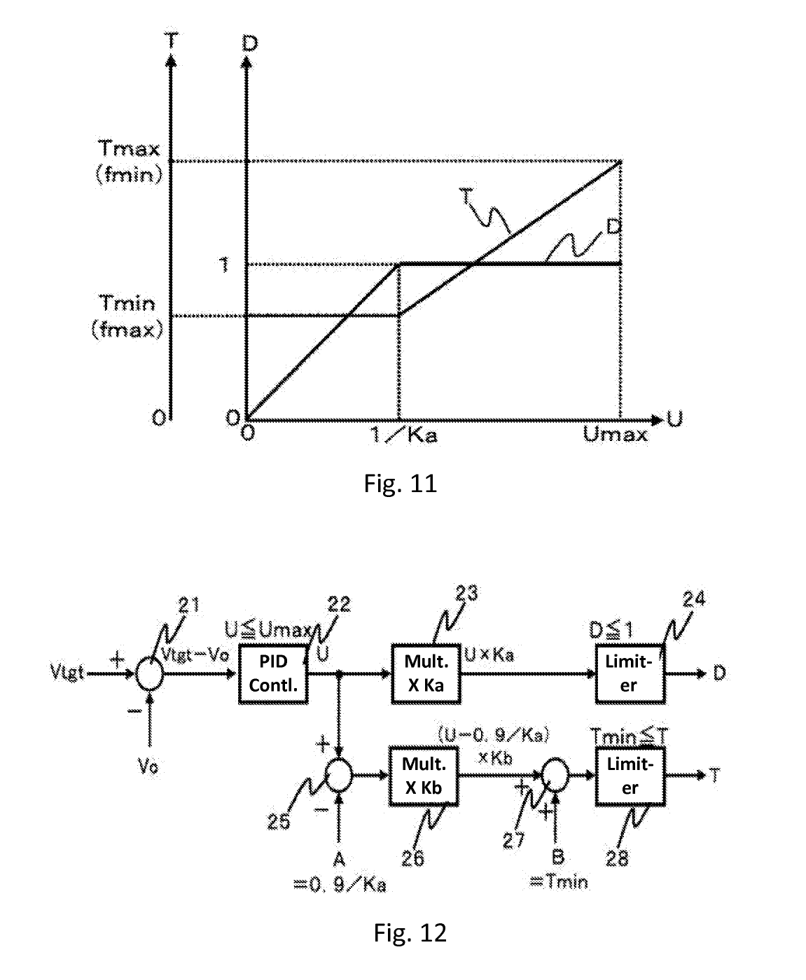

Next, a fifth embodiment is explained with reference to FIG. 11. Specifically, the embodiment relates to the following condition: when a switching frequency of the current resonant converter 3 is smaller than the maximum frequency fmax, a step-down operation of the step-down converter 2 should be stopped. When a time ratio is equal to 1, the step-down converter 2 stops the step-down operation and outputs an input voltage without voltage conversions. Thus, as shown in FIG. 11, the maximum time ratio Dmax is set to 1. Further, when the second constant A is set to 1/Ka, the time ratio is maintained to be 1 in a range of the operation variable U between 1/Ka and Umax. On the other hand, a command value for a cycle T for adjusting a switching frequency fsw of the current resonant converter 3 is changed in the above range in accordance with change of the operation variable U.

Further, in the above setting, the switching frequency fsw of the current resonant converter 3 is maintained to be the maximum frequency fmax in a range of the operation variable U between 0 and 1/Ka. On the other hand, a command value for adjusting a time ratio D of the step-down converter 2 is changed in the above range in accordance with change of the operation variable U.

### Sixth Embodiment

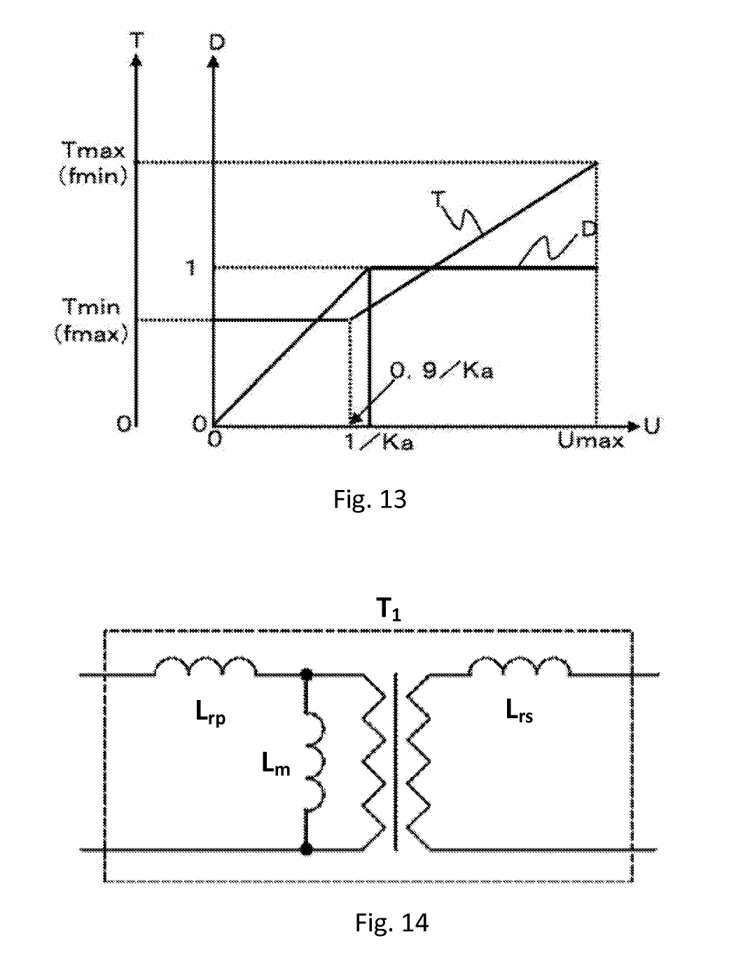

Next, a sixth embodiment is explained with reference to FIGS. 12 and 13. Note that because the reference numerals shown in FIG. 12 correspond to the same reference numerals shown in 9, the explanations thereof are omitted in the sixth embodiment. Specifically, the embodiment relates to the following condition: within a limited range of the operation variable U, both changes of the time ratio D and the cycle T based on change of the operation variable U are permitted. In a control system according to the sixth embodiment of the present invention shown in FIG. 12, the maximum time ratio Dmax is set to 1 and the second constant A is set to 0.9/Ka.

In a case in which the above condition is satisfied, when the operation variable U exceeds 1/Ka, the time ratio D is set to 1 as shown in FIG. 13. On the other hand, when the operation variable U exceeds 0.9/Ka, the cycle T starts to change based on change of the operation variable U. Therefore, when the operation variable U is in a range between 0.9/Ka and 1/Ka, not only the time ratio D is changed based on the change of the operation variable U, but also the cycle T is changed based on the change of the operation variable U.

Configuration of Current Resonant Converter

Next, a configuration of a resonance circuit in a current resonant converter according to an embodiment of the present invention is explained with reference to the drawings. In the resonance circuit, an inductor with respect to a series resonance (a series resonance inductor) and an inductor with respect to a parallel resonance (a parallel resonance inductor) are configured as follows: FIG. 14 shows a series resonance inductor that is configured with leakage inductors Lrp and Lrs of a transformer T1. In this case, the resonance circuit is configured by loosely coupling a transformer T1 and connecting a resonance capacitor to the transformer T1. At this time, a coupling coefficient of the transformer T1 is set to substantially 0.8 through 0.9. Further, an excitation inductor Lm of the transformer T1 corresponds to a parallel resonance inductor.

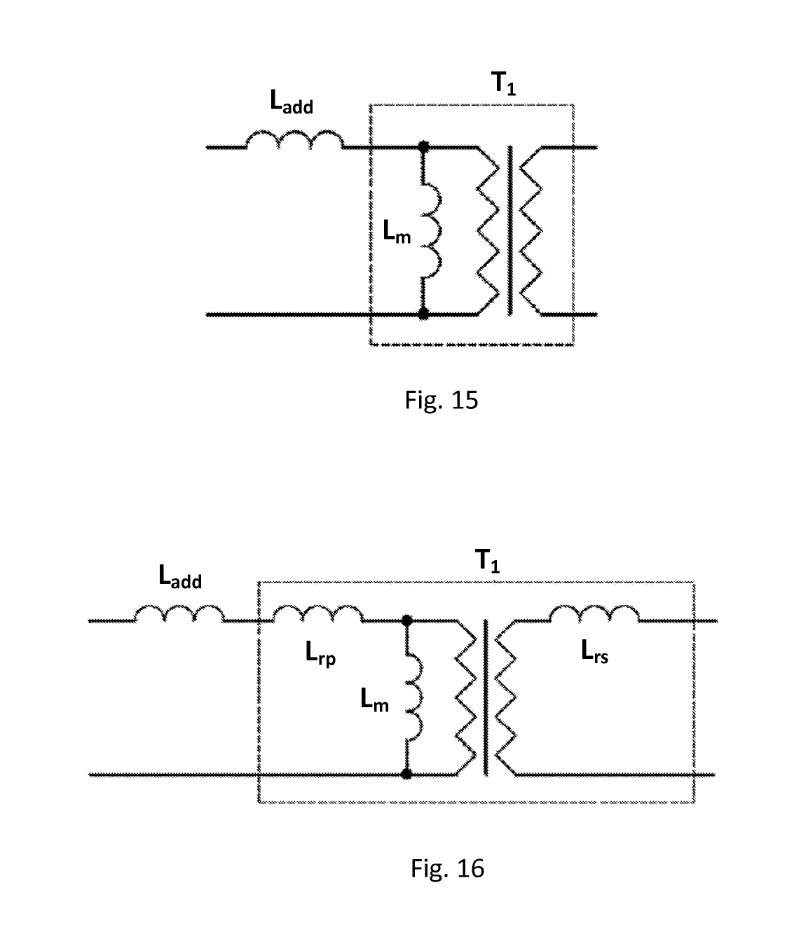

FIG. 15 shows a series resonance inductor that is configured with an external inductor Ladd. In this case, a resonance circuit is configured by tightly coupling a transformer T1 and connecting the external inductor Ladd and a resonance capacitor to the transformer T1. Further, in FIG. 15 as well as FIG. 14, an excitation inductor Lm of the transformer T1 corresponds to a parallel resonance inductor.

FIG. 16 shows a series resonance inductor that is configured with an external inductor Ladd and leakage inductors Lrp and Lrs. In this case, a resonance circuit is configured by loosely coupling a transformer T1 and connecting the external inductor Ladd and a resonance capacitor to the transformer T1. Further, in FIG. 16 as well as FIGS. 14 and 15, an excitation inductor Lm of the transformer T1 corresponds to a parallel resonance inductor.

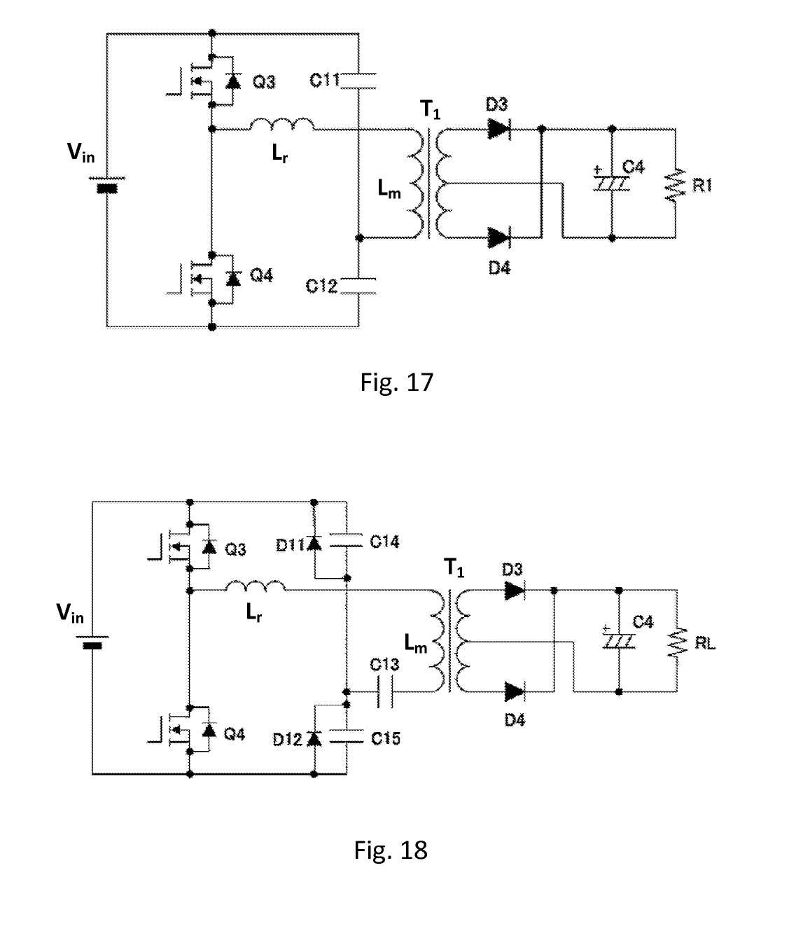

Next, a configuration of a resonance capacitor in a resonance circuit according to an embodiment of the present invention is explained with reference to the drawings. FIG. 17 shows a resonance capacitor that is configured with capacitors C11 and C12. In this case, the capacitors C11 and C12 are connected in series to both terminals of a DC power source Vin as shown in FIG. 17. Further, one end of a primary winding of a transformer T1 is connected to a node connected between the capacitors C11 and C12.

FIG. 18 shows a resonance capacitor that is configured with capacitors C13, C14 and C15. In this case, the capacitors C14 and C15 are connected in series to both terminals of a DC power source Vin. Further, the capacitor C13 is connected between one end of a primary winding of a transformer T1 and a node connected between the capacitors C14 and C15. Further, diodes D11 and D12 may also be connected to the capacitors C14 and C15 respectively in parallel for overload protection for the capacitor C14 and C15. In this embodiment, the capacitor C14 and the diode D11 are connected in parallel. In this connection, a cathode terminal of the diode D11 is connected to a positive electrode side of the DC power source Vin. Further, the capacitor C15 and the diode D12 are connected in parallel. In this connection, an anode terminal of the diode D12 is connected to a negative electrode side of the DC power source Vin. Further, output voltage drooping can be realized by connecting the diodes D11 and D12 as explained above.

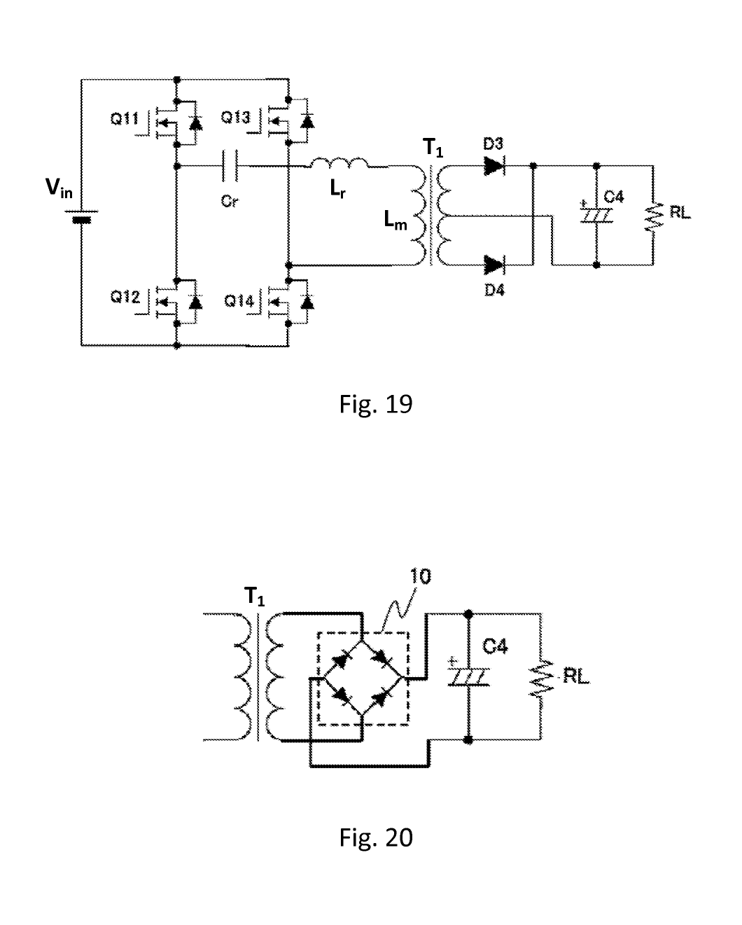

The current resonant converter that is configured as a half bridge type is used in the first through sixth embodiments. However, a current resonant converter that is configured as a full bridge type can also be used as shown in FIG. 19. In this circuit, transistors (FETs) Q11 and Q12 are connected in series to both terminals of a DC power source Vin. Further, transistors (FETs) Q13 and Q14 are also connected in series to the both terminals of the DC power source Vin. A node connected between the transistors (FETs) Q11 and Q12 is connected to one end of a primary winding of a transformer T1 through a capacitor Cr and an inductor Cr with which a current resonance circuit is configured. A node connected between the transistors (FETs) Q13 and Q14 is connected to the other end of the primary winding of the transformer T1. The transistors (FETs) Q11 and Q14 are turned ON at the same time and the transistors (FETs) Q12 and Q13 are turned ON at the same time. A set of the transistors (FETs) Q11 and Q14 and a set of the transistors (FETs) Q12 and Q13 are alternatively turned ON in between a dead time at a time ratio of substantially 50%.

Further, a rectifying circuit that is provided at a secondary side of a transformer T1 can also be a diode bridge 10 as shown in FIG. 20.

As explained above, the current resonant converter that forms a part of the converter according to the embodiments of the present invention has various configurations. As long as the current resonant converter is configured to adjust the voltage transfer factor by the switching frequency of the switching element in which the resonance current flows, the configuration is not limited to the above embodiments. Therefore, the current resonant converter in which a capacitor is connected to a primary winding or a secondary winding of the transformer T1 in parallel (referred to as a LCC converter) can also be adopted. Further, as long as an element is configured so as to perform a step-down operation, the configuration is not limited to the above embodiments.

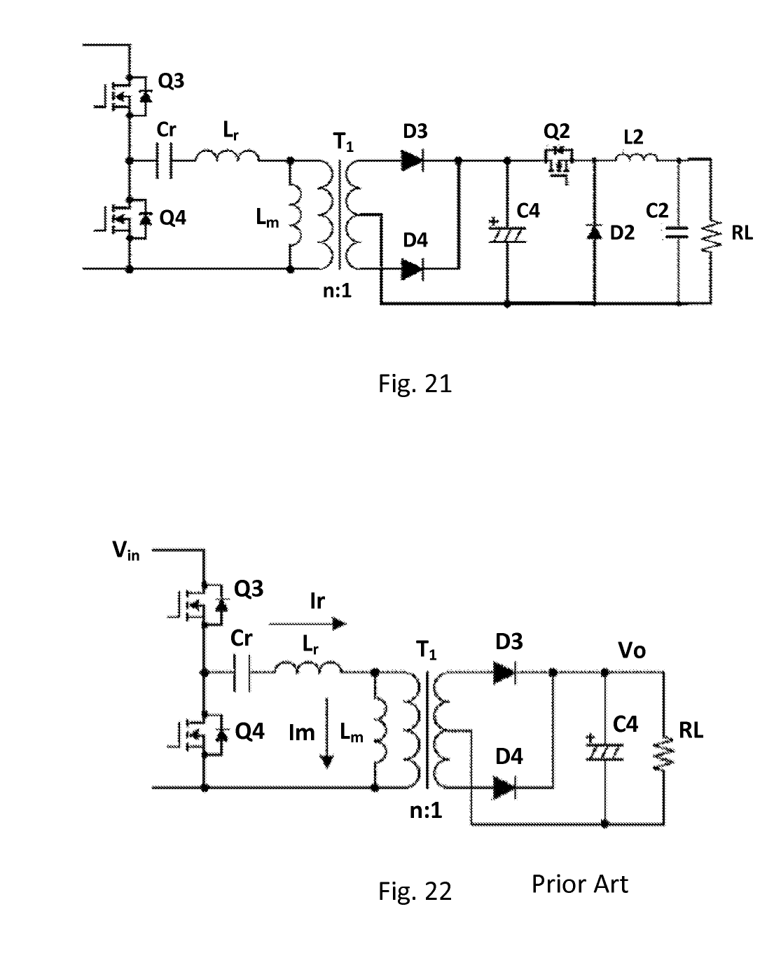

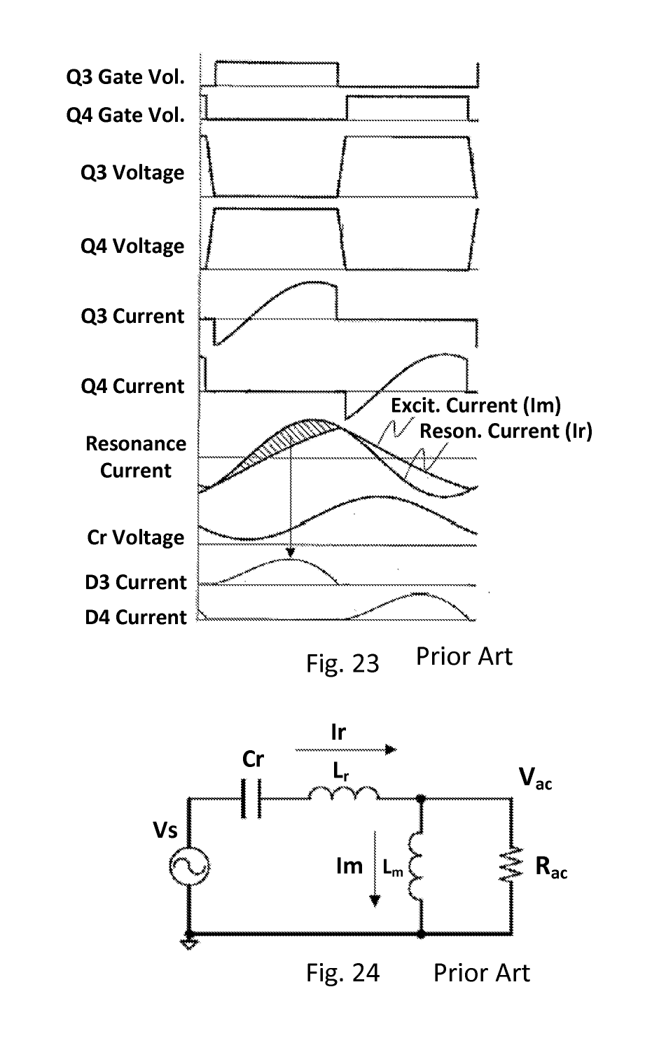

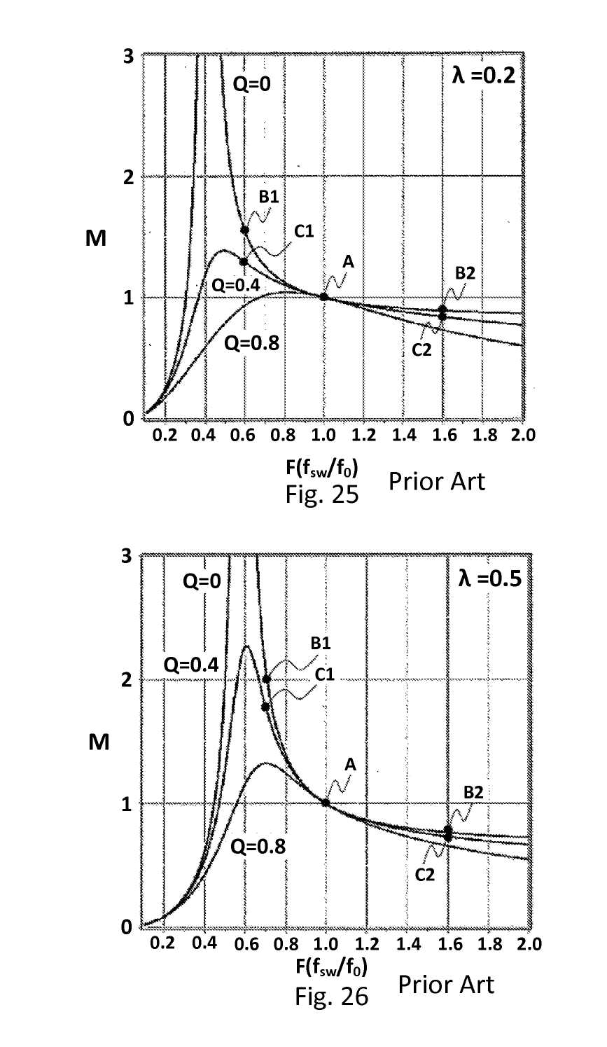

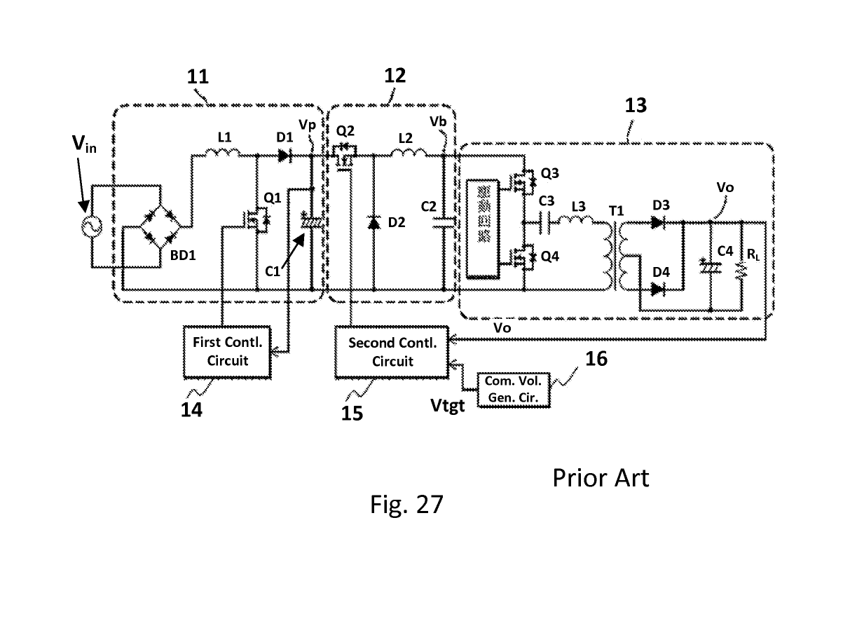

In the embodiments explained above, the cases in which the step-down converter is connected to an upstream end (e.g., a former part, an input side, or a front side) of the current resonant converter are explained. However, in the embodiments of the present invention, a case in which the step-down converter is connected to a downstream end (e.g., a latter part, an output side, or a rear side) of the current resonant converter can also be adopted. That is, as shown in FIG. 21, a configuration in which an output of a current resonant converter is connected to an input of a step-down converter can also be adopted. Further, when the step-down converter is connected to a latter part of the current resonant converter as explained above, operations of the step-down converter and the current resonant converter are controlled so as to make a output voltage that is output from the step-down converter to be the same as a target voltage that is supplied from a command voltage generation circuit.

The DC-DC converter and the power supply device having the DC-DC converter being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A DC-DC converter, comprising:
a step-down converter that outputs a first output voltage having a first voltage value that is the same as an input voltage when a step-down operation stops and that outputs the first output voltage having a second voltage value that is lower than the input voltage when the step-down operation is performed;
a resonant converter communicating with the step-down converter, a voltage transfer factor of the resonant converter being adjusted by a switching frequency of a switching element through which a resonance current flows;
an output voltage detection circuit communicating with one of the step-down converter and the resonant converter, the output voltage detection circuit that detects one of the first output voltage and a second output voltage that is output from the resonant converter as a detected voltage; and
a control circuit communicating with the step-down converter and the resonant converter, the control circuit that has first and second controllers and that controls the step-down converter and the resonant converter based on the one of the first and second output voltages detected by the output voltage detection circuit, wherein
the first controller adjusts the voltage transfer factor of the resonant converter by changing the switching frequency between a first predetermined frequency and a second predetermined frequency that is larger than the first predetermined frequency, and
the second controller performs the step-down operation and adjusts a step-down ratio of the step-down operation under a predetermined condition.

2. The DC-DC converter according to claim 1, wherein
the predetermined condition is a state in which the switching frequency reaches the second predetermined frequency.

3. The DC-DC converter according to claim 2, wherein
the step-down converter is connected to an upstream end of the resonant converter, and
the output voltage detection circuit detects the second output voltage as the detected voltage.

4. The DC-DC converter according to claim 2, wherein
the resonant converter is connected to an upstream end of the step-down converter, and
the output voltage detection circuit detects the first output voltage as the detected voltage.

5. The DC-DC converter according to claim 1, wherein
the first controller adjusts the voltage transfer factor in a range that is equal to or more than a predetermined minimum voltage transfer factor, and
the predetermined condition is a state in which the voltage transfer factor reaches the predetermined minimum voltage transfer factor.

6. The DC-DC converter according to claim 5, wherein
the step-down converter is connected to an upstream end of the resonant converter, and
the output voltage detection circuit detects the second output voltage as the detected voltage.

7. The DC-DC converter according to claim 5, wherein
the resonant converter is connected to an upstream end of the step-down converter, and
the output voltage detection circuit detects the first output voltage as the detected voltage.

8. A DC-DC converter, comprising:
a step-down converter that outputs a first output voltage having a first voltage value that is the same as an input voltage when a step-down operation stops and that outputs the first output voltage having a second voltage value that is lower than the input voltage when the step-down operation is performed;
a resonant converter communicating with the step-down converter, a voltage transfer factor of the resonant converter being adjusted by a switching frequency of a switching element through which a resonance current flows;
an output voltage detection circuit communicating with one of the step-down converter and the resonant converter, the output voltage detection circuit that detects one of the first output voltage and a second output voltage that is output from the resonant converter as a detected voltage;
a command voltage generation circuit communicating with one of the step-down converter and the resonant converter, the command voltage generation circuit that outputs a target value for one of the first output voltage and the second output voltage; and
a control circuit communicating with the step-down converter and the resonant converter, the control circuit that has first and second controllers and that controls the step-down converter and the resonant converter based on the target value and the one of the first and second voltages detected by the output voltage detection circuit, wherein
the first controller adjusts the voltage transfer factor of the resonant converter by changing the switching frequency between a first predetermined frequency and a second predetermined frequency that is larger than the first predetermined frequency,
the second controller performs the step-down operation and adjusts a step-down ratio of the step-down operation when the target value is equal to or less than a predetermined value, and
the step-down ratio is determined based on the target value.

9. The DC-DC converter according to claim 8, wherein
the step-down converter is connected to an upstream end of the resonant converter, and
the output voltage detection circuit detects the second output voltage as the detected voltage.

10. The DC-DC converter according to claim 8, wherein
the resonant converter is connected to an upstream end of the step-down converter, and
the output voltage detection circuit detects the first output voltage as the detected voltage.

11. A DC-DC converter, comprising:
a step-down converter in which a time ratio of a switching operation is controlled by pulse width modulation control, the step-down converter outputting a first output voltage;
a resonant converter communicating with the step-down converter, the switching frequency of the step-down converter being controlled by the pulse width modulation control, the resonant converter outputting a second output voltage;
an operation variable generator communicating with one of the step-down converter and the resonant converter, the operation variable generator that generates an operation variable based on one of the first and second output voltages and a target value of the one of the first and second output voltages;
a first command value generator communicating with the operation variable generator, the first command value generator that generates a first command value based on a first calculation value to adjust the time ratio, the first calculation value being obtained by multiplying the operation variable with a first constant; and
a second command value generator communicating with the operation variable generator, the second command value generator that generates a second command value based on a second calculation value to adjust the switching frequency, the second calculation value being obtained by subtracting a second constant from the operation variable to generate a subtracted value, multiplying the subtracted value with a third constant to generate a multiplied value, and adding a fourth constant to the multiplied value, wherein
the first command value generator restricts the first calculation value to be equal to or less than a first restriction value that corresponds to a maximum time ratio in the pulse width modulation control, the first command value generator generates the first command value based on the restricted first calculation value,
the second constant is set to be equal to or less than a value obtained by dividing the first restriction value by the first constant,
the third constant is set to a second restriction value that is obtained based on a maximum switching frequency in the pulse width modulation control, and
the second command value generator restricts the second calculation value to be equal to or more than the second restriction value, the second command value generator generates the second command value based on the restricted second calculation value.

12. The DC-DC converter according to claim 11, wherein
the step-down converter is connected to an upstream end of the resonant converter, and
the operation variable generator generates the operation variable based on the second output voltage and the target value of the second output voltage.

13. The DC-DC converter according to claim 11, wherein
The resonant converter is connected to an upstream end of the step-down converter, and
the operation variable generator generates the operation variable based on the first output voltage and the target value of the first output voltage.

14. The DC-DC converter according to claim 11, wherein
the second constant is lower than the value obtained by dividing the first restriction value by the first constant.

15. The DC-DC converter according to claim 14, wherein
the first restriction value is equal to 1.

16. The DC-DC converter according to claim 11, wherein
the first restriction value is equal to 1.

17. A power supply device comprising:
the DC-DC converter according to claim 2.

18. A power supply device comprising:
the DC-DC converter according to claim 5.

19. A power supply device comprising:
the DC-DC converter according to claim 8.

20. A power supply device comprising:
the DC-DC converter according to claim 11.
